(19) United States
(12) Patent Application Publication
(10) Pub. No.: US 2010/0136179 A1
(43) Pub. Date: Jun. 3, 2010

(54) POUCHED LIQUID FOOD PRODUCT

(75) Inventors: Koji Mochizuki, Tokyo (JP); Aoi Saito, Tokyo (JP); Atsushi Kanemaru, Tokyo (JP); Yoshihiro Yoshida, Tokyo (JP); Shingo Masai, Hiroshima (JP)

Correspondence Address: OLIFF & BERRIDGE, PLC, P.O. BOX 320850, ALEXANDRIA, VA, 22320-4850, US

(73) Assignees: Q.P. CORPORATION, Tokyo (JP); AOHATA CORPORATION, Takehara-shi ,Hiroshima (JP)

(21) Appl. No.: 12/451,650

(22) PCT Filed: May 30, 2008
(86) PCT No.: PCT/JP2008/060030

§ 371 Date: Nov. 23, 2009

(30) Foreign Application Priority Data
May 31, 2007 (JP) 2007-145955
Jan. 10, 2008 (JP) 2008-003757

(51) Int. Cl. B65D 81/34; B65D 85/72; A23L 1/01; B65D 81/32; B65D 75/62

(52) U.S. Cl. 426/87; 426/107; 426/243; 426/123; 426/120

(57) ABSTRACT

A pouched liquid food product from which a delicious dish can be cooked with a microwave oven without the color, smell, texture and the like of the food ingredients being harmed has a pouch having a zipper portion and a steam venting mechanism. The pouch is filled with a liquid food and sealed, and a liquid substance in the liquid food has a viscosity at 60° C. of 0.1 to 10 Pa·s. The relationship between the liquid food and a solid ingredient satisfies at least one of the following conditions (a) to (d):
(a) the liquid food has a salt concentration which is 110 to 400% of the salt concentration of the whole contents after addition of the solid ingredient;
(b) a liquid surface of the liquid substance in the pouch, when the pouched liquid food product is made to have a posture for cooking with a microwave oven after adding the solid ingredient into the pouch, is at a height of 1/10 to ½ the height from a lower edge of the contents to an upper edge of the contents;
(c) a maximum filling volume of the pouch is 2 to 10 times the volume of the filled amount of the liquid food; and
(d) an expected addition amount of the solid ingredient is 0.1 to 5 parts by mass based on 1 part by mass of the liquid substance included in the liquid food.

### TECHNICAL FIELD

The present invention relates to a pouched liquid food product from which a consumer can easily and deliciously prepare a dish, in which a solid ingredient such as a fresh food is used, by adding the solid ingredient into a pouch filled with a liquid food which has undergone retort processing, and cooking with a microwave oven. More particularly, the present invention relates to a pouched liquid food product from which a delicious heated dish in which a vegetable such as Chinese cabbage, broccoli and the like is used, can be easily prepared at home by cooking with a microwave oven.

### BACKGROUND ART

Examples of developed pouched food products include a pouched food product obtainable by sealing a pouch filled with a dish, such as a pre-cooked curry, a soup and the like, and subjecting the pouch to a retort processing, where the pouched food product is configured so as to become easily eatable just by heating with a microwave oven; a pouched food product obtainable by sealing a pouch filled with food raw ingredients and a condiment liquid, where the pouched food product is configured so as to be cooked with a microwave oven; and a pouched food product obtainable by filling a pouch filled with food raw ingredients and sealing the pouch, where the pouched food product is configured such that water and a condiment liquid can be added to the pouched food products upon cooking with a microwave oven (Patent Documents 1 and 2).

[Patent Document 1] Japanese Patent Application Laid-Open No. Hei 8-224059
[Patent Document 2] Japanese Patent Application Laid-Open No. Hei 2006-44708

### DISCLOSURE OF THE INVENTION

### Problems to be Solved by the Invention

However, of food ingredients, some ingredients can lose their color and smell, or water can seep out, when a pouch is filled with the precooked ingredients and the pouch is reheated for eating. Furthermore, some meats and fish become tough unless cooking thereof is carried out within a short time, and the optimum cooking time varies depending on food ingredients. Moreover, of dishes, some dishes require that the food ingredients have a high level of freshness.

Thus, even if a pouched food product in which a pouch is filled with a completely-cooked dish is heated with a microwave oven, there were limits on the deliciousness of the resultant dish. In particular, while pouched food products which have undergone retort processing have the convenience of being storable at ordinary temperatures, they also suffer from the drawback that the dish loses the flavor thereof and the like due to excessive heating upon the retort processing. Furthermore, for pouched food products containing various unheated food ingredients in a pouch which are to be cooked all together with a microwave oven, such pouched food products also suffer from the drawback that it is more difficult for the food ingredients to be stirred during the cooking compared with heating in a pot or the like. Also, due to the characteristics of microwave-heating, in which the food ingredients are directly heated and the heating is finished in a short time, the flavor balance of the overall dish deteriorates. Moreover, since the cooking time is made to match the cooking time of the food ingredient which requires the longest cooking time, there were limits on the deliciousness of the resultant dish.

On the other hand, there are requests from households which would like to be able to prepare a delicious dish which can be easily cooked and seasoned using the fresh foods in season.

Problems like the above also occur for vegetable food ingredients such as leaf vegetables like Chinese cabbage, flower vegetables like broccoli, and root vegetables like potatoes and daikon radishes. For example, the desirable texture and taste specific to these vegetable food ingredients can be drawn out by carrying out appropriate heat processing, thereby enabling a delicious dish to be obtained. If the heat processing is insufficient, raw portions of such vegetable food ingredients will remain. On the other hand, if the heat processing is excessive, the composition becomes too soft, and the texture is not desirable.

Therefore, even if a pouched liquid food product is obtained by filling a pouch with a heated dish which uses a vegetable, such as the above-described Chinese cabbage, broccoli and sealing the pouch, and then subjecting the pouch to retort processing, not only is the texture of such vegetable harmed due to excessive heating from the retort processing, the problem also arises that the condiment component becomes over-soaked in the vegetable, so that the flavors of the raw ingredients themselves are harmed and the whole dish tends to have a very uniform flavor.

While concentrated condiments, such as Chinese-style miso, are commercially available which allow a delicious heated dish using a vegetable, such as Chinese cabbage, to be produced at home, in such cases it is necessary to use a pot or a frying pan. This cannot be said to be simple.

In view of such problems in the conventional art, it is an object of the present invention to enable cooking to be easily carried out by utilizing microwave-heating, and to enable a delicious dish to be prepared without the color, smell, texture and the like of the food ingredients being harmed, even for a dish which uses food ingredients that require heating for a short duration, food ingredients which should not be stored for a long period of time after cooking, or food ingredients which are required to be fresh. Furthermore, it is an object of the present invention to enable a delicious microwave-heated dish to be produced by effectively using ingredients such as fresh foods which a consumer happens to have at hand. In particular, it is an object of the present invention to provide a pouched liquid food product which allows a delicious dish that uses a vegetable, such as Chinese cabbage, broccoli and the like to be easily produced at home by utilizing microwave-heating.

### Means for Solving the Problems

As a result of extensive studies to achieve the above-described objects of the present invention, the present inventors found that a pouched liquid food product at least satisfying the conditions:

(i) that, concerning solid ingredients in which color, smell, texture and the like deteriorate due to prolonged heating, and especially solid ingredients which need to be fresh, a solid ingredient provided by the consumer, and not a solid ingredient which has undergone retort processing in a pouch, is used;

(ii) that a pouch having a zipper portion which can be opened and sealed is filled with other food ingredients (as a liquid food having been subjected to retort processing in advance so that the resultant liquid food could be stored for a long duration) and sealed, thereby allowing the solid ingredient provided by the consumer to be added into the pouch at a suitable time and microwave-heated; and

(iii) that a liquid substance in such a liquid food is adjusted to a specific viscosity, can realize the above-described objects.

In addition, the present inventors also found that these conditions alone are insufficient to confer a good flavor, texture, and appearance to a heated dish obtained by microwave-cooking using a pouched liquid food product.

Thus, the present inventors carried out further studies concerning the point that the above conditions alone are insufficient to confer a good flavor, texture, and appearance to a heated dish obtained by microwave-cooking using a pouched liquid food product. As a result, the present inventors came to the conclusion that for such a pouched liquid food product, when cooking using a microwave oven, to confer a good flavor, texture, and appearance to the heated dish, sufficient consideration needs to be given to the quantitative relationship between the solid ingredient to be added and the liquid food. Namely, when the consumer adds the solid ingredient into a pouch which is filled with a liquid food and which is provided with a zipper portion that can be opened and sealed, a good flavor, texture, and appearance can be conferred to the heated dish if the amount of the added solid ingredient matches the expected addition amount of the solid ingredient. However, if such amounts do not match, the above-described advantageous effect is unlikely to be obtained.

Under such circumstances, the present inventors carried out even more studies about the quantitative relationship between the solid ingredient to be added and the liquid food. As a result, the present inventors discovered that this quantitative relationship could be grasped from the factors of:

(a) “the salt concentration of the liquid food with respect to the salt concentration of the whole contents after addition of the solid ingredient”;

(b) “the liquid immersing ratio of the solid ingredient filled in the pouch”;

(c) “the filled amount of the liquid food with respect to the volume of the pouch”; and

(d) “the added amount of the solid ingredient with respect to the liquid food”.

Furthermore, the present inventors found that a pouched liquid food product satisfying, in addition to the above-described conditions (i) to (iii), a specific condition relating to at least one of these factors (a) to (d) could achieve the above-described objects of the present invention.

Namely, the present invention provides a pouched liquid food product, comprising a liquid food and a pouch filled therewith and sealed, the pouched liquid food product being subjected to retort processing and being configured such that a heated dish is obtainable by adding a solid ingredient into the pouch and cooking with a microwave oven, wherein:

the pouch has a zipper portion which serves as an addition aperture of the solid ingredient and a steam venting mechanism for discharging steam during cooking with a microwave oven;

a liquid substance in the liquid food has a viscosity at 60° C. of 0.1 to 10 Pa·s; and

a relationship between the liquid food and the solid ingredient satisfies at least one of following conditions (a) to (d).
(a) The liquid food has a salt concentration which is 110 to 400% of a salt concentration of the whole contents after addition of the solid ingredient.
(b) A liquid surface of the liquid substance in the pouch, when the pouched liquid food product is made to have a posture for cooking with a microwave oven after adding the solid ingredient into the pouch, is at a height of 1/10 to ½ the height from a lower edge of the contents to an upper edge of the contents.
(c) A maximum filling volume of the pouch is 2 to 10 times the volume of a filled amount of the liquid food.
(d) An expected addition amount of the solid ingredient is 0.1 to 5 parts by mass based on 1 part by mass of the liquid substance included in the liquid food.

Furthermore, the present invention provides a method for cooking or producing a heated dish, comprising opening the zipper portion of the above-described pouched liquid food, adding a solid ingredient from the zipper portion into the pouch, closing the zipper portion, and cooking with a microwave oven.

In addition, in their studies of more specific modes for achieving the objects of the present invention, the present inventors invented specific modes A and B, which will be described in more detail below.

Namely, the present inventors discovered that the objects of the present invention could be achieved even by, when cooking with a microwave oven, using a solid ingredient provided by the consumer for solid ingredients in which color, smell, texture and the like deteriorate due to prolonged heating, and especially for solid ingredients which need to be fresh, filling a pouch with other food ingredients (as a liquid food having being subjected to retort processing in advance so that the resultant liquid food could be stored for a long duration), thereby allowing the solid ingredient provided by the consumer to be added into the pouch at a suitable time and microwave-heated, and suppressing the loss in taste due to retort processing even for the liquid food which is to undergo retort processing in advance by making the thickness of the pouch when the pouched liquid food is placed flat equal to or less than a specific thickness. As a result, the present inventors completed specific mode A.

Therefore, the present invention provides, as specific mode A, a pouched liquid food product, comprising a liquid food and a pouch filled therewith and sealed, the pouched liquid food product being subjected to retort processing and being configured such that a heated dish is obtainable by adding a solid ingredient into the pouch filled with the liquid food and cooking with a microwave oven, wherein:

the pouch has a zipper portion which serves as an addition aperture of the solid ingredient and a steam venting mechanism for discharging steam during cooking with a microwave oven;

a liquid substance in the liquid food has a viscosity (60° C.) of 0.1 to 10 Pa·s;

the liquid food has a salt concentration which is 110 to 400% of a salt concentration of the whole contents after addition of the solid ingredient; and

a pouch thickness when the pouched liquid food product is placed flat is 2 cm or less.

Furthermore, the present invention provides a method for cooking or producing a heated dish, comprising opening the zipper portion of the above-described pouched liquid food, adding a solid ingredient from the zipper portion into the pouch, closing the zipper portion, and cooking with a microwave oven.

Furthermore, the present inventors tested the idea that the above-described problems could be resolved if the vegetable, such as Chinese cabbage, broccoli and the like, to be used was provided by the consumer, and a pouch was filled with other food ingredients, such as a condiment and the like whose texture is not easily affected by the level of heating (as a liquid food having being subjected to retort processing in advance so that the resultant liquid food could be stored for a long duration) and sealed, thereby allowing the vegetable provided by the consumer to be added into the pouch at an appropriate time and microwave-cooked.

As a result, in the obtained heated dish, the texture of the vegetable, such as Chinese cabbage, broccoli and the like, was greatly improved, compared with when a cooked heated dish was subjected to retort processing as is conventionally carried out. However, unlike heating carried out in a pot or the like, microwave-heating has the characteristic that the heating temperature cannot be adjusted, so that a strong heating at a high temperature is unevenly carried out. Thus, strong heating for a certain length of time needs to be carried out so that unheated portions due to uneven heating do not remain. In such a case, the overall heat processing conditions can become too strong, thereby harming the texture of the vegetable, such as Chinese cabbage, broccoli and the like. Furthermore, the condiment component can also become over-soaked in the vegetable, whereby the flavor of such vegetable is itself harmed.

As a result of further extensive studies, the present inventors discovered that a delicious heated dish having the desirable texture and taste specific to a vegetable, such as Chinese cabbage, broccoli and the like, drawn out can be obtained by adjusting the viscosity of the liquid substance in the liquid food to a specific level using a specific thickener, and starting the microwave-cooking in a state where most of the vegetable added into the pouch is exposed above the liquid substance, even if the heating by the microwave oven is excessive. Based on this discovery, the present inventors completed specific mode B which achieves the objects of the present invention.

Accordingly, the present invention provides, as specific mode B, a pouched liquid food product, comprising a liquid food which includes a condiment and a pouch which is filled therewith and sealed, the pouched liquid food product being subjected to retort processing and being configured such that a heated dish is obtainable by adding one kind or two or more kinds of vegetables selected from leaf vegetables, flower vegetables, and root vegetables into the pouch filled with the liquid food and cooking with a microwave oven, wherein:

the pouch has a zipper portion which serves as an addition aperture of the vegetable and a steam venting mechanism for discharging steam during cooking with a microwave oven;

a liquid substance in the liquid food includes a modified starch and/or a moist heat-treated starch, and the liquid substance has a viscosity of 0.1 to 10 Pa·s; and

a liquid surface of the liquid substance in the pouch, when the pouched liquid food product is made to have a posture for cooking with a microwave oven after adding the vegetables into the pouch, is at a height of 1/10 to ½ the height from a lower edge of the contents to an upper edge of the contents.

### Advantages of the Invention

According to the pouched liquid food product of the present invention, the food ingredients, which exclude the solid ingredient which is expected to be added into the pouch during cooking, are subjected to retort processing. The pouch was filled with the food ingredients as a liquid food with a viscosity adjusted to a specific level. Therefore, the consumer can store this pouched liquid food product. Furthermore, the consumer can also easily obtain a heated dish in which a solid ingredient is used, by adding the solid ingredient which is expected to be added into this pouched liquid food product at an appropriate time into the pouch, and cooking the solid ingredient in the pouch together with the liquid food with a microwave oven. In this case, since the liquid food in the pouch has undergone retort processing, the microwave-heating time may be set to a required duration for the cooking of the solid ingredient. Thus, the problem of the solid ingredient being excessively heated in order to match the heating time of the other food ingredients can be resolved.

Furthermore, when the liquid food in the pouch is adjusted to a specific salt concentration, since the liquid food can easily mix over all of the added solid ingredient because it is in liquid form, the solid ingredient can be cooked so as to have a delicious flavor.

If the a liquid surface of the liquid substance in the pouch, when the pouched liquid food product is made to have a posture for cooking with a microwave oven after adding the solid ingredient into the pouch, is at a height of 1/10 to ½ the height from a lower edge of the contents to an upper edge of the contents, the microwave-cooking can be started in a state where most of the solid ingredient added into the pouch is exposed above the liquid substance. As a result, the solid ingredient can be turned into a braised state, which allows the problems of the texture of the solid ingredient being harmed from excessive heating, and the condiment component becoming over-soaked in the solid ingredient, which causes the flavor of the raw ingredients themselves to be harmed and the whole dish to become a uniform flavor, to be resolved.

When the maximum filling volume of the pouch is 2 to 10 times the volume of the filled amount of the liquid food, the liquid food and the solid ingredient can be easily brought into contact after addition of the solid ingredient into the pouch. Moreover, if as many solid ingredients as possible are to be added into the pouch while still allowing the pouch to be sealed for microwave-cooking, defining the maximum filling volume of the pouch to be 2 to 10 times the volume of the filled amount of the liquid food allows the filled amount of the solid ingredient to be quantified. This means that, regardless of the consumer, a roughly constant good flavor, texture, and appearance can be conferred to the heated dish.

Even when the expected addition amount of the solid ingredient is 0.1 to 5 parts by mass based on 1 part by mass of the liquid substance included in the liquid food, the microwave-cooking can be carried out in a state where most of the solid ingredient added into the pouch is exposed above the liquid substance.

Therefore, according to the pouched liquid food product of the present invention, a delicious dish which harnesses the color, smell, texture and the like of the solid ingredient can be produced even if the solid ingredient is a food ingredient whose color, smell and texture tends to deteriorate due to excessive heating, a food ingredient from which water tends to seep out, a food ingredient for which freshness is important and the like.

Furthermore, for the consumer, when the food ingredients at hand, such as a fresh food, match the kind of solid ingredient which is expected to be used for this pouched liquid food product, the consumer can easily produce a delicious microwave-heated dish by utilizing the food ingredients at hand. In particular, if the liquid food with which the pouch is pre-filled is a food which takes time to cook, using this pouched food product is very convenient for the consumer.

### BRIEF DESCRIPTION OF THE DRAWINGS

FIG. 1 is a perspective view of a pouched liquid food product of a first embodiment according to the present invention.

FIG. 2 is a side view of a state where the pouched liquid food product is placed flat.

FIG. 3 is a side view of the pouched liquid food product when the pouched liquid food product is made to have a posture for cooking with a microwave oven after adding the solid ingredient into the pouch.

FIG. 4 is a perspective view of the pouched liquid food product with its zipper portion opened so that the solid ingredient can be added thereto.

### DESCRIPTION OF REFERENCE NUMERALS

1 pouched liquid food product
10 pouch
11 side edge seal portion
12 upper edge seal portion
13 zipper portion
14 zipper seal portion
15 notch
16 notch
17 steam venting mechanism
18 weakened seal portion
19 notch
20 solid ingredient
21 upper edge of content
30 liquid food
31 liquid surface
32 lower edge of content
40 descriptive indication
50 flat plate

### BEST MODE FOR CARRYING OUT THE INVENTION

The present invention will now be described in more detail with reference to the drawings. In the drawings, reference numerals which are the same represent the same or similar elements. Furthermore, in the present invention, unless stated otherwise, “%” represents “mass %”, and “parts” represents “parts by mass”.

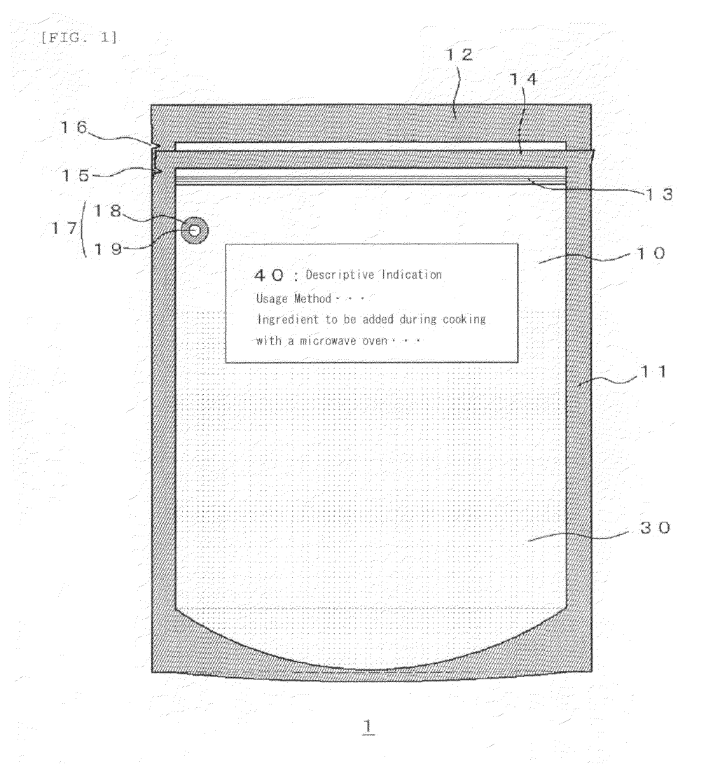

FIG. 1 is a perspective view of a pouched liquid food product 1 of a first embodiment according to the present invention.

This pouched liquid food product 1 is obtainable by filling a pouch 10 formed from a microwavable film material with a pre-cooked liquid food 30 and sealed, and performing retort processing. When the pouched liquid food product 1 is eaten, it is prepared by adding a given solid ingredient into the pouch 10, and cooking with a microwave oven. Preferred examples of this retort processing include carrying out heating which is equivalent to heating a center portion of the food at 120° C. for 4 minutes, or pressurizing heating processing under conditions having a similar or higher effectiveness.

First, the liquid food 30 constituting the pouched liquid food product 1 of the present invention will be described.

The liquid food 30, with which the pouch 10 is filled and sealed, is subjected to retort processing.

The liquid food 30 is used in order to obtain a final dish just by adding a solid ingredient to the liquid food 30 and heating with a microwave oven to season the solid ingredient. Therefore, the liquid food 30 is preferably formed from the food ingredients necessary for the dish which is to be finally obtained, excluding the solid ingredient to be added prior to the microwave-heating. Furthermore, it is preferred to carry out preparatory cooking, such as removing scum, preliminary flavoring, heating and the like as required.

The liquid substance in the liquid food 30 has a viscosity increased to a specific level using a thickener so that a delicious heated dish can be produced which draws out the desirable texture and taste specific to the solid ingredient 20 even when excessive microwave-heating is carried out. Namely, the viscosity at 60° C. of the liquid substance in the liquid food 30 of the present invention is 0.1 to 10 Pa·s, preferably 1 to 10 Pa·s, and more preferably 1 to 5 Pa·s.

In the present invention, as described below, the microwave-cooking is started in a state where most of the solid ingredient 20 added into the pouch 10 is exposed above a liquid surface 31 of this liquid substance. Therefore, the cooking proceeds in a state where most of the solid ingredient is not immersed in the liquid food 30 including a condiment. This means that unevenness tends to occur in the flavoring of the solid ingredient during the cooking. The liquid food 30 and the solid ingredient 20 are stirred by opening the pouch 10 after heating with the microwave oven and transferring the contents onto a plate. However, if the viscosity of the liquid substance is higher than the above-described range, it is difficult for the liquid substance to spread over the whole solid ingredient, which makes it difficult to eliminate the unevenness of the dish seasoning.

On the other hand, in the present invention, although the microwave-cooking is started in a state where most of the solid ingredient 20 added into the pouch 10 is exposed above the liquid surface 31 of this liquid substance, the cooking still proceeds with a part of the solid ingredient immersed in the liquid food 30. Therefore, when the viscosity of the liquid substance is lower than the above-described range, the texture of the added solid ingredient 20 is harmed due to excessive heating. Furthermore, the condiment component becomes over-soaked in the vegetable, so that the flavor of the raw ingredients themselves is harmed and the whole dish tends to become a uniform flavor.

While the liquid food may include various kinds of thickener to adjust the viscosity, it is preferred that the liquid food includes a modified starch and/or a moist heat-treated starch. If thickeners other than these are used, when the liquid food 30 and the solid ingredient 20 are stirred by opening the pouch 10 after the microwave-heating and transferring the contents onto a plate, perhaps because the adhesiveness of the liquid substance is too strong, it tends to be difficult to spread the liquid substance over the whole vegetable, which makes it difficult to eliminate the unevenness of the dish flavoring.

Here, the viscosity of the liquid substance in the liquid food is a value determined by the reading when the rotor has rotated three times after measurement start, using a BH type viscometer on the liquid substance in the liquid food at a product temperature of 60° C. and a rotation speed of 20 rpm with a No. 1 rotor for a viscosity of less than 0.375 Pa·s, a No. 2 rotor for a viscosity of 0.375 Pa·s or more to less than 1.5 Pa·s, a No. 3 rotor for a viscosity of 1.5 Pa·s or more to less than 3.75 Pa·s, a No. 4 rotor for a viscosity of 3.75 Pas·s or more to less than 7.5 Pa·s, and a No. 5 rotor for a viscosity of 7.5 Pa·s or more. Here, if a solid ingredient is included in the liquid food 30, the liquid substance, namely, a substance obtained by passing the liquid food through a 10 mesh to remove the solid ingredient, is measured.

The modified starch used in the present invention is not especially limited as long as such chemically-processed starch can be used as a thickener, and can be used in food. Examples thereof include crosslinked starches, oxidized starches, etherified starches, esterified starches and the like, subjected to one kind or two or more kinds of chemical processing, such as crosslinking, esterification, etherification, oxidation and the like, by a common method on raw starch, such as wheat starch, cornstarch, potato starch, tapioca starch and the like, as a raw material. One kind or two or more kinds of these may be used.

Furthermore, the moist heat-treated starch used in the present invention is not especially limited as long as it is sold commercially as a “moist heat-treated starch”. The moist heat-treated starch may be produced, for example, by a method in which starch particles, which contain moisture in an amount where the particles do not gelatinize even if heated, are heated at about 100 to 125° C. under conditions of 100% relative humidity in a sealed container. Alternatively, the moist heat-treated starch may be produced by a depressurizing/pressurizing heating method, which is a system in which, in a first stage, starch is charged into a container and the container is sealed and depressurized, and in a second stage, live steam is charged into the container and humidification and heating are carried out.

The blended amount of the modified starch and/or moist heat-treated starch for adjusting the viscosity of the liquid substance to the above-described range depends on the kind of starch used, the components of the liquid food and the like. However, preferably this amount is, based on the total amount of the blended raw materials excluding the solid ingredient, about 0.1 to 10%, and more preferably about 0.5 to 5%.

The flavoring of the liquid food 30 is performed such that, based on the salt concentration of the whole contents after addition of the solid ingredient, the salt concentration of the liquid food 30 is made to be 110 to 400%, preferably 110 to 300%, and more preferably 150 to 300%. By doing so, a delicious dish in which the added solid ingredient and the flavor of the liquid food is well mixed with a good balance can be obtained. Namely, in conventional microwave-cooking, compared with heating in a pot or the like, it is more difficult to stir the food ingredients. In addition, because the food ingredients are directly heated and the heating is finished in a short period of time, it is difficult to obtain a dish in which the solid ingredient and the flavor of the condiment liquid is well mixed with a good balance. However, in the present invention, as already described above, the flavoring of the liquid food in the dish which is thus finally obtained has a fixed ratio. Therefore, despite cooking with a microwave oven, a delicious dish in which the added solid ingredient and the flavor of the liquid food is well mixed with a good balance can be obtained. In contrast, if this ratio is too high, a large amount of non-seasoned solid ingredient is seasoned by a small amount of strongly-flavored liquid food. As a result, a delicious dish in which the added solid ingredient and the flavor of the liquid food is well mixed with a good balance cannot be obtained. On the other hand, if this ratio is too low, it is difficult to obtain the ingredient feeling of the solid ingredient. Here, the term “salt concentration” means the concentration of sodium chloride or the equivalent salt-converted concentration.

The salt concentration of the liquid food 30 is preferably 4% or less. If the salt concentration of the liquid food 30 is excessively high, the difference in flavor with the non-flavored solid ingredient is too large, so that the harmoniousness in taste between the liquid food and the solid ingredient tends to deteriorate. While the flavoring of such a liquid food 30 is somewhat strong compared with the flavoring of the finally-intended heated dish after the addition of the solid ingredient, it is not a strong flavoring like the so-called flavoring miso. Rather, it is a flavoring which can be eaten even before addition of the solid ingredient.

The salt concentration of the whole contents after the solid ingredient 20 is added is usually 0.5 to 3%, although this depends on the kind of intended dish.

The salt concentration is determined by preparing a sample by an ordinary method by diluted acid extraction, measuring the sodium content by atomic absorption, and multiplying the obtained sodium content by a given coefficient (2.54) to calculate the value.

In the present invention, the solid ingredient 20 which is expected to be added prior to the cooking with the microwave oven is one kind or two or a plurality of kinds of solid food ingredient. This solid ingredient 20 does not contain only water or a condiment liquid. Specific examples of the solid ingredient 20 may be appropriately selected from among food ingredients which, due to retort processing, (1) tend to ooze with water, (2) tend to lose color, (3) have a smell that is easily harmed, (4) tend to become mushy, (5) tend to become tough, and (6) are required to be fresh, for each kind of dish which is to be finally obtained by microwave-heating. Examples of solid ingredients which may be used include one kind or two or more kinds selected from leaf vegetables, flower vegetables, root vegetables, fruit vegetables, fruit, seafood, meats, mushrooms, and seaweeds. Among these, leaf vegetables, flower vegetables, and root vegetables can be preferably used. Here, the term “leaf vegetables” refers to vegetables from which the leaf is utilized for eating. Examples thereof include Chinese cabbage, cabbage, Japanese mustard spinach, bok-choy, lettuce, spinach, garland chrysanthemum, basil, potherb mustard, Malabar nightshade and the like. The term “flower vegetables” refers to vegetables from which the flower is utilized for eating. Examples thereof include broccoli, cauliflower, field mustard, horsetail and the like. Furthermore, the term “root vegetables” refers to vegetables from which the root is utilized for eating. Examples thereof include tubers such as potatoes and sweet potatoes, daikon radishes, carrots, turnips and the like. Examples of fruit vegetables include eggplants, zucchinis, green peppers and the like. Examples of fruit include strawberries, blueberries, peaches and the like. Examples of seafood include sea bass, sardines, mackerel, octopus, cuttlefish, short-necked clams, Omar lobster, mussels and the like. Examples of farmed meats include chicken, pork, beef, mutton and the like. Examples of mushrooms include maitake mushrooms, shimeji mushrooms and the like. Examples of seaweed include hijiki, kombu and the like.

When adding the solid ingredient 20 into the pouch 10, it is preferred to cut the solid ingredient 20 to have a thickness of 0.1 to 4 cm so that the cooking with the microwave oven can be carried out without any unevenness. Furthermore, optionally, before adding into the pouch, preparatory cooking such as pre-boiling, pre-frying, removing scum and the like may be carried out.

In the present invention, the weight ratio of the liquid food 30 and the solid ingredient 20 which is expected to be added depends on the kind and the shape of the solid ingredient 20 to be added. However, the expected addition amount of the solid ingredient 20 is, based on 1 part by mass of the liquid substance included in the liquid food 30, preferably 0.1 to 5 parts by mass, more preferably 0.2 to 4 parts by mass, and even more preferably 0.3 to 3 parts by mass.

From the point of obtaining a delicious heated dish, the expression “microwave-cooking” used in the present invention means, per 100 g total amount of the liquid food 30, with which the pouch 10 is filled and sealed, and the solid ingredient 20 added to the pouch 10, heating preferably under a condition of a power equivalent to 600 W×3 minutes or greater, and more preferably under a condition of a power equivalent to 600 W×3 minutes to 10 minutes. Here, “equivalent to 600 W×3 minutes” refers to microwave-heating under conditions which are calculated to be the same or greater than a value obtained by multiplying the number of output watts by time, such as 6 minutes for a power of 300 W, 4.5 minutes for a power of 400 W, and 2.25 minutes for a power of 800 W.

Next, the pouch 10 constituting the pouched liquid food product 1 of the present invention for microwave-cooking will be described.

As illustrated in FIG. 1, the pouch 10 is a flat bag-shaped retort pouch configured by a standing pouch. This standing pouch is formed from a plastic film folded over and overlapped so as to form a gusset on the bottom, with a side edge seal portion 11 and an upper edge seal portion 12 formed by heat sealing of both side edge portions and the top edge portion. A zipper portion 13 is provided near the upper edge seal portion 12 of one side of the pouch 10.

A heat sealed zipper seal portion 14 is formed further outward from the zipper portion 13. At the side edge seal portion 11 near this zipper seal portion 14, a notch 15 is formed on a part above the zipper portion 13 for enabling the zipper portion 13 to be opened by tearing off the zipper seal portion 14. By thus providing the zipper seal portion 14 outward from the zipper portion 13, a sealed state can be maintained without opening the zipper portion 13 during retort processing.

Furthermore, at the side edge seal portion 11, a notch 16 is formed between the zipper portion 13 and the upper edge seal portion 12 for forming an aperture portion for discharging the dish by tearing. If this notch 16 is formed, the dish in the pouch 10 can be poured onto a plate by tearing and opening the upper edge portion of the pouch 10 from this notch 16. Since the cooked pouch 10 is extremely hot, this allows the dish in the pouch 10 to be poured onto a plate more safely than when the dish in the pouch 10 is poured onto a plate by opening the zipper portion 13. Furthermore, since the contents are stirred by transferring them onto the plate in one go, heating unevenness in the dish can be easily eliminated.

Furthermore, a steam venting mechanism 17 for preventing the pouch 10 from over-expanding and bursting during microwave-heating is provided on a surface of the pouch 10. As the steam venting mechanism 17, a mechanism may be provided which has conventionally been used for microwavable packaging bags. For example, such mechanism may have a weakened seal portion 18 near the side edge seal portion 11, and have a notch 19 formed in that weakened seal portion 18. Furthermore, in the steam venting mechanism 17 of the pouch 10, the fit of the zipper portion may be adjusted so that the sealed zipper portion 13 partially opens from pressure produced when the pouch 10 expands during microwave-heating.

In the present invention, so long as the pouch is a bag-shaped retort pouch which has a steam venting mechanism and which can be cooked with a microwave oven, the structure of the pouch itself is not limited to being a flat bag, and pouches of various shapes may be used. For example, in addition to a standing pouch provided with a gusset on the bottom face, a gusset bag provided with gussets on the bottom face and on the side faces, a three-side sealed bag, a four-side sealed bag, a pillow bag and the like may be used. Among these, bags which are called “flat bags”, such as a standing pouch provided with a gusset on the bottom face, and a gusset bag provided with gussets on the bottom face and on the side faces, can be preferably used.

However, regarding the volume of the pouch 10, the maximum filling volume of the pouch 10 is preferably sufficiently bigger than the total volume of the filled amount of the liquid food 30 and the added amount of the solid ingredient 20 so that the liquid food 30 and the solid ingredient 20 can easily come into contact with each other after the solid ingredient 20 is added into the pouch 10. More specifically, it is preferred to set the maximum filling volume to 2 to 10 times the volume of the filled amount of the liquid food 30, preferably 2 to 8 times that volume, and more preferably 4 to 8 times that volume. For this reason, pouches having a gusset, such as the above-described standing pouch provided with a gusset on the bottom face and a gusset bag provided with a gusset also on the side faces, are preferred.

Furthermore, specifying the maximum filling volume of the pouch filled with the liquid food to be 2 to 10 times the filled amount of the liquid food also means that, as described above, the added amount of the solid ingredient can be quantified. Here, the expression “maximum filling volume of the pouch” means the maximum volume which can be filled and sealed in the pouch when the zipper portion 13 of the pouch is closed. Measurement of the maximum filling volume can be carried out by filling the pouch with a full amount of fresh water and sealing the pouch, and then measuring the volume of fresh water in the pouch with a graduated cylinder or the like.

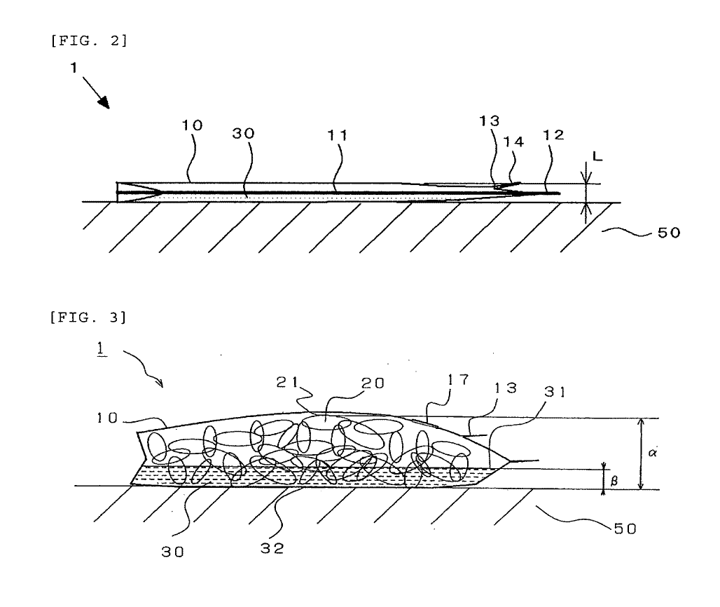

Furthermore, while uniformly heating without unevenness the center portion and the peripheral portion of the liquid food during the retort processing, in order to heat the center portion in a manner equivalent to heating at 120° C. for 4 minutes even if the heating conditions are eased, a pouch thickness L (hereinafter, simply referred to as “pouch thickness”) when the pouch filled with the liquid food 30 is placed flat on a flat plate 50 and flattened out is made to be 2 cm or less, preferably 1.5 cm or less, and more preferably 1 cm or less, as illustrated in FIG. 2. If the pouch thickness L when filled with the liquid food 30 is too thick, during the retort processing of the liquid food 30, for the center portion to be heated for an equivalent heating at 120° C. for 4 minutes, the peripheral portion is excessively heated, which can cause the taste to deteriorate. In addition, since waste in terms of the costs of the pouch material can increase if the pouch thickness L is too thin, the pouch thickness is preferably 0.3 cm or more.

For rigid molded containers, even if the container can be used for cooking with a microwave oven, it is difficult to achieve both a thickness of 2 cm or less, which is required as described above to uniformly heat the liquid food without unevenness between the center portion and the peripheral portion during the retort processing, and a sufficiently large size as the maximum filling volume of the container with respect to the total volume of the filled amount of the liquid food and the added amount of the solid ingredient. Therefore, rigid molded containers are not preferable as a container for the pouched liquid food product 1.

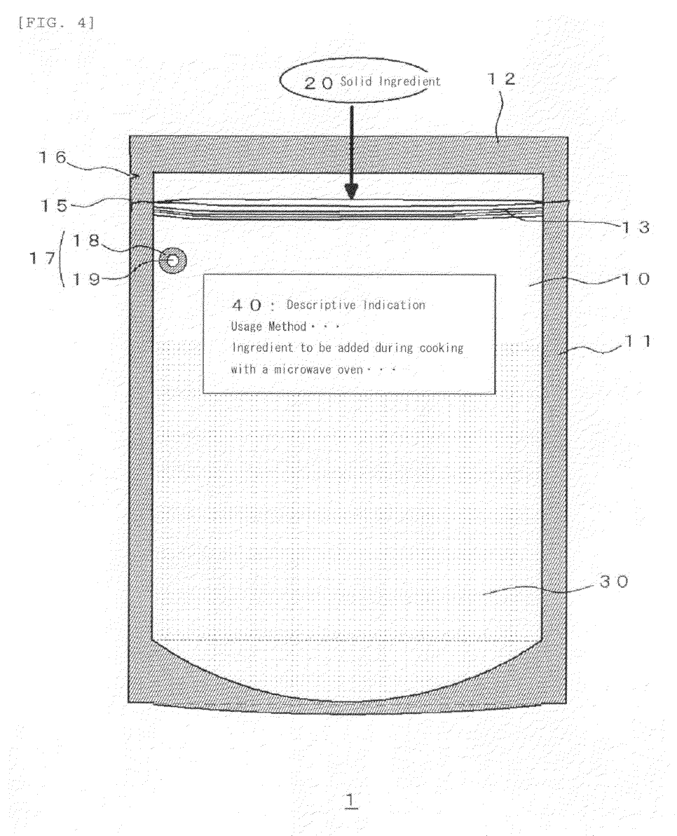

In the present invention, after the solid ingredient 20 is added into the pouch 10, the zipper portion 13 is closed, the pouch is placed in the microwave oven and cooking is started. At this stage, the microwave-cooking is started in a state where most of the solid ingredient 20 added into the pouch is exposed above a liquid surface 31 of the liquid substance. Namely, in the present invention, the liquid surface 31 of the liquid substance in the pouch, when the pouched liquid food product is made to have a posture for cooking with a microwave oven after adding the solid ingredient 20 into the pouch 10, is at a height of 1/10 to ½ the height, and preferably 1/10 to ⅖ the height, from a lower edge 32 of the contents to an upper edge 21 of the contents. This means that if the height from the lower edge 32 of the contents to the liquid surface 31 of the liquid substance is β, and the height from the lower edge 32 of the contents to the upper edge 21 of the contents is α when the pouch is allowed to stand still in a posture for microwave-cooking as illustrated in FIG. 3, then β/α is 1/10 to ½, and preferably 1/10 to ⅖.

Thus, if the microwave-cooking is started in a state where most of the solid ingredient 20 added into the pouch 10 is exposed above the liquid surface 31, the cooking proceeds in a state where most of the solid ingredient is not immersed in the liquid food. This means that the solid ingredient 20 exposed above the liquid surface 31 is also heated by steam produced from the direct heating of the liquid food and the solid ingredient by the microwave oven, a so-called “steaming effect”. As the cooking of the solid ingredient 20 proceeds further, the volume of the solid ingredient 20 gradually shrinks, so that the height of the liquid surface 31 tends to relatively increase. However, the crucial point is that, at least during the first half stage of the cooking by the microwave oven, most of the solid ingredient 20 is cooked in an exposed state. As described above, in addition to adjusting the viscosity of the liquid substance to a specific level using a preferred thickener, by cooking in the above manner, a delicious heated dish can be produced which draws out the desirable texture and taste specific to the solid ingredient 20 even when excessive heating by the microwave oven is carried out. In contrast, if the liquid surface 31 of the liquid substance is higher than the above height, when the microwave-cooking is started in a state where most of the solid ingredient 20 added into the pouch 10 is immersed, the texture of the solid ingredient is harmed due to excessive heating even if the viscosity of the liquid substance is in the above range. Furthermore, the condiment component becomes over-soaked in the solid ingredient 20, so that the flavor of the raw ingredients themselves is harmed and the whole dish tends to have a very uniform flavor. On the other hand, if the liquid surface 31 of the liquid substance is lower than the above height, and the microwave-cooking is started in a state where most of the solid ingredient 20 added into the pouch 10 is not immersed therein, even when the liquid food 30 and the solid ingredient 20 are stirred by opening the pouch 10 heated with the microwave oven and transferring the contents onto a plate, unevenness in the flavoring of the dish cannot be eliminated.

Specific examples of the heated dish which is to be finally obtained, the liquid food 30 used therein, and the solid ingredient 20 which is expected to be added include the following. For example, when the dish to be finally obtained by microwave-heating is a vegetable dressed with a thick starchy sauce, a leaf vegetable, such as Chinese cabbage, cabbage and the like, which can serve as a leaf vegetable and a main material and from which water easily seeps out by retort processing, is expected as the solid ingredient to be added prior to microwave-heating. Furthermore, as the liquid food in the pouch, examples include a paste- or soup-like liquid substance cooked in a Chinese or Japanese style which includes ground meat, a vegetable such as carrot and onion.

When the dish to be finally obtained by microwave-heating is a boiled green vegetable and broth, green vegetables such as Japanese mustard spinach, spinach, basil and the like, which easily lose their color from retort processing, are expected as the solid ingredient to be added prior to microwave-heating. Furthermore, as the liquid food with which the pouch are to be filled, examples include a Japanese style condiment liquid formed from sugar and soy sauce as a base, or a broth formed by optionally adding other ingredients such as deep-fried tofu (“aburaage” in Japanese) and the like to such a condiment liquid.

When the dish to be finally obtained by microwave-heating is a dish in which a fruit is used, strawberries, blueberries and the like, which tend to lose their color and flavor from retort processing, are expected as the solid ingredient to be added prior to microwave-heating. Furthermore, as the liquid food with which the pouch is to be filled, examples include a sauce which includes a condiment.

When the dish to be finally obtained by microwave-heating is a creamed soup of pumpkin or a tuber, pumpkin and tubers such as potato, taro and the like, which are the main material of the creamed soup and which tend to become mushy from retort processing, are expected as the solid ingredient to be added prior to microwave-heating. Furthermore, as the liquid food with which the pouch is to be filled, examples include a cream sauce obtained by cooking cream, cheese, mushrooms and the like.

When the dish to be finally obtained by microwave-heating is a pot-au-feu, flower vegetables such as cauliflower and the like, which can be the main material of the pot-au-feu, and tubers such as potato and the like, which tend to become mushy from retort processing, are expected as the solid ingredient to be added prior to microwave-heating. Furthermore, as the liquid food with which the pouch is to be filled, examples include a soup-like food obtained by stewing meat, root vegetables, onions and the like in consomme.

When the dish to be finally obtained by microwave-heating is a seafood or meat stew, seafood such as short-necked clams, squid, mackerel, cod and the like, and farmed meats such as sirloin, pork loin, chicken leg, which are the main materials of such a stew and which tend to become tough from retort processing, are expected as the solid ingredient to be added prior to microwave-heating. Furthermore, as the liquid food with which the pouch is to be filled, examples include a condiment liquid formed from a bouillon base as a base, a condiment liquid formed from tomato paste as a base, a condiment liquid formed from miso as a base and the like.

When the dish to be finally obtained by microwave-heating is a mushroom pasta sauce, mushrooms such as maitake (Grifola frondosa), shimeji (champignon) and the like, whose smell tends to be harmed from retort processing, are expected as the solid ingredient to be added prior to microwave-heating. Furthermore, as the liquid food to be filled with which the pouch is to be filled, examples include a pasta sauce in which onions, garlic and the like are used.

When the dish to be finally obtained by microwave-heating is a boiled food made from hijiki, kombu or the like, seaweeds such as hijiki, kombu and the like, whose smell tends to be harmed from retort processing, are expected as the solid ingredient to be added prior to microwave-heating. Furthermore, as the liquid food with which the pouch is to be filled, examples include a heated condiment liquid formed from sugar, soy sauce, and “dashi” (Japanese soup stock) as a base.

When the dish to be finally obtained by microwave-heating is a dish made from field mustard, horsetail or the like, field mustard, horsetail and the like, which require an especially high degree of freshness and which should not be repeatedly heated, are expected as the solid ingredient to be added prior to microwave-heating. Furthermore, as the liquid food with which the pouch is to be filled, examples include a heated condiment liquid and the like formed from sugar, soy sauce, and “dashi” (Japanese soup stock) as a base.

Thus, the contents of the liquid food and the solid ingredient can be selected from among various ingredients. Furthermore, since various ingredients may also be used for the flavor and components of the heated dish, the pouched liquid food product of the present invention can provide an applicable heated dish (so-called nursing food or hospital food) even for consumers for whom the ingestion of certain components is not allowed or is suppressed (e.g., diabetic patients, patients suffering from metabolic syndrome etc.), or consumers having difficulty in chewing and swallowing.

Furthermore, the pouched liquid food product 1 of the present invention preferably has a descriptive indication 40 describing the kind of dish which is to be finally obtained by microwave-heating, the kind of solid ingredient which is expected to be added into the pouch when microwave-heating, a preferred cut shape, size, and added amount of that solid ingredient, the method for adding that solid ingredient into the pouch, the pouch posture during microwave-heating, the number of Watts and duration required for the microwave-heating, the method for opening the pouch after microwave-heating and the like. In particular, the added amount and size of the solid ingredient, the pouch posture during microwave-heating, and the number of Watts and duration for the microwave-heating have a large influence on the completion level of the dish after the microwave-heating, and it is thus preferable to clearly indicate such matters on the pouched liquid food product 1.

As illustrated in FIG. 1, the descriptive indication 40 may be formed by printing it on the surface of the pouch 10, by printing it on an external packaging such as a packing box or the like of the pouched liquid food product 1, or by printing it on a separate piece of paper from the pouch 10 and attaching that piece of paper to the pouched liquid food product 1.

The pouched liquid food product 1 may be produced by preparing the pouch 10 with the upper edge seal portion 12 in an unsealed state, filling the liquid food 30 into the pouch 10, heat sealing the upper edge seal portion 12, and subjecting the pouch 10 to retort processing. The retort processing may be preferably performed by carrying out heating equivalent to heating a center portion of the food at 120° C. for 4 minutes by an ordinary method, or pressurizing heating processing under conditions having a similar or higher effectiveness.

The pouched liquid food product 1 of the present invention can be applied to a method for cooking or producing a heated dish. The method for cooking or producing a heated dish is characterized by opening a zipper portion of the pouched liquid food product of the present invention, adding a solid ingredient from the zipper portion into the pouch, closing the zipper portion, and cooking with a microwave oven. Furthermore, this method for cooking or producing a heated dish also has an aspect as a method for using the pouched liquid food product. This method for using is characterized by opening a zipper portion of the pouched liquid food product of the invention, adding a solid ingredient from the zipper portion into the pouch, closing the zipper portion, and cooking with a microwave oven.

The method for using the pouched liquid food product, and the method for cooking or producing a heated dish will now be described in more detail.

First, depending on the kind of dish the consumer wishes to make, and the fresh food ingredients at hand, the pouched liquid food product for producing a given dish is selected, the solid ingredient to be added thereto is determined based on the description on the descriptive indication, and cutting, weighing and the like are carried out.

Next, as illustrated in FIG. 4, the pouch 10 is torn from the notch 15 in the outward of the zipper portion 13 of the pouched liquid food product 1 to remove the zipper seal portion 14. Then, the zipper portion 13 is opened, and the solid ingredient 20 is added into the pouch 10 as illustrated by the arrow. In this case, a small amount of washing water which adhered during washing of the solid ingredient 20 and a small amount of a condiment which adhered during the pre-processing of the solid ingredient 20 may be included, along with the solid ingredient, in the pouch 10. However, other than the solid ingredient, the addition of water and a condiment into the pouch 10 for the purpose of adjusting the flavor or the like should be avoided as much as possible. Addition of such materials is undesirable because, for example, if water is added, unevenness occurs in the concentration of the liquid food in contact with the solid ingredient in the pouch, which can also cause unevenness to occur in the flavor of the solid ingredient after the microwave-heating. Furthermore, a scum removing sheet may optionally be added into the pouch during addition of the solid ingredient.

Next, the zipper portion 13 is closed, and then microwave-heating is carried out at a predetermined number of Watts and for a predetermined duration with the pouch 10 laid flat or stood up so that the steam venting mechanism 17 is facing upwards to prevent the contents from easily spilling out of the steam venting mechanism 17. At this stage, in addition to the liquid food 30 and the solid ingredient 20 being directly heated by the microwave-heating, because the zipper portion is closed, the liquid food 30 and the solid ingredient 20 are also heated by the produced steam, a so-called “steaming effect”. Furthermore, since the steam is discharged from the steam venting mechanism 17, the pouch is prevented from bursting even if it expands. Thus, a delicious dish can be produced in which the liquid food 30 filled in the pouch 10 and the solid ingredient 20 are suitably cooked. Furthermore, after the cooking, it is preferred to immediately tear off an upper edge portion of the pouch 10 from the notch 16 near the upper edge seal portion 12 to open the pouch, pour the dish in the pouch 10 onto a large plate in one go, and then optionally dish out into individual portions. Even if the heating of the dish in the pouch 10 is uneven, by pouring the dish in the pouch 10 onto a large plate, the dish is stirred, which makes equalization of the temperature of the dish. Furthermore, the cooked pouch 10 is very hot, so that a person finds it difficult to carry out the action of opening the zipper portion 13 with his/her hand. However, by tearing off an upper edge portion of the pouch 10 from the notch 16 in this way to remove the dish, the opening action can be performed safely.

While the pouched liquid food product of the present invention was described above, there are four specific modes satisfying just one of the conditions (a) to (d), six specific modes satisfying two of the conditions (a) to (d), four specific modes satisfying three of the conditions (a) to (d), and one specific mode satisfying all four of the conditions (a) to (d). Generally, the more conditions that are satisfied, the better the obtained effects tend to be.

Among these specific modes, examples of preferred modes include the following specific modes A and B, which are described in more detail in the below-described examples.

Specific mode A satisfies condition (a), and has a pouch thickness when the pouched liquid food product is placed flat of 2 cm or less. Furthermore, specific mode B satisfies condition (b), and the solid ingredient is one kind or two or more kinds of vegetable selected from leaf vegetables, flower vegetables, and root vegetables.

Specific mode A is:

“A pouched liquid food product, comprising a liquid food and a pouch filled therewith and sealed, the pouched liquid food product being subjected to retort processing and being configured such that a heated dish is obtainable by adding a solid ingredient into the pouch filled with the liquid food and cooking with a microwave oven, wherein:

the pouch has a zipper portion which serves as an addition aperture of the solid ingredient and a steam venting mechanism for discharging steam during cooking with a microwave oven;

a liquid substance in the liquid food has a viscosity (60° C.) of 0.1 to 10 Pa·s;

the liquid food has a salt concentration which is 110 to 400% of a salt concentration of the whole contents after addition of the solid ingredient; and

a pouch thickness when the pouched liquid food product is placed flat is 2 cm or less.”.

According to the pouched liquid food product of this specific mode A, the food ingredient, which excludes the solid ingredient which is expected to be added into the pouch during cooking, is subjected to retort processing and filled into the pouch as a liquid food with a viscosity increased to a specific level. Therefore, the consumer can store this pouched liquid food product. Furthermore, the consumer can also easily obtain a heated dish in which a solid ingredient is used, by adding the solid ingredient which is expected to be added into this pouched liquid food product at an appropriate time into the pouch, and cooking the solid ingredient in the pouch along with the liquid food with a microwave oven. In this case, since the liquid food in the pouch has undergone retort processing, the microwave-heating time may be set to the required duration for the cooking of the solid ingredient. Thus, the problem of the solid ingredient being excessively heated in order to match the heating time of the other food ingredients can be resolved. Furthermore, since the liquid food can easily mix over all of the added solid ingredient because it has a salt concentration adjusted to a specific level and is in liquid form, the solid ingredient can be cooked so as to have a delicious flavor. In addition, the pouched liquid food product has a specific pouch thickness or less when placed flat. Moreover, even for the liquid food which is subjected to retort processing in advance, the loss in taste due to the retort processing is suppressed.

Therefore, according to the pouched liquid food product of specific mode A, a delicious dish which harnesses the color, smell, texture and the like of the solid ingredient can be produced even if the solid ingredient is a food ingredient whose color, smell, texture and the like tends to deteriorate due to excessive heating, a food ingredient from which water tends to seep out, a food ingredient for which freshness is important and the like.

Furthermore, for the consumer, when the food ingredients at hand, such as a fresh food, match the kind of solid ingredient which is expected to be used for this pouched liquid food product, the consumer can easily produce a delicious microwave-heated dish by utilizing the food ingredients at hand. In particular, if the liquid food with which the pouch is pre-filled is a food which takes time to prepare, using this pouched food product is very convenient for the consumer.

Specific mode A includes the following preferred modes 1) to 9). The details of these modes have already been described above, and thus a description thereof is omitted here.
1) A mode in which the liquid food has a salt concentration of 4% or less.
2) A mode in which the liquid food has undergone preparatory cooking before the retort processing.
3) A mode including a descriptive indication about a kind and an added amount of the solid ingredient which is suitable for addition into the pouch.
4) A mode in which the expected addition amount of the solid ingredient is 0.1 to 5 parts by mass based on 1 part by mass of the liquid substance included in the liquid food.
5) A mode in which the solid ingredient is one kind or two or more kinds selected from leaf vegetables, flower vegetables, root vegetables, fruit vegetables, fruit, seafood, farmed meats, mushrooms, and seaweeds.
6) A mode in which a notch for forming an aperture portion for discharging the dish by tearing is formed in the pouch.
7) A mode in which the heated dish is a nursing food or a hospital food.
8) A mode relating to a method for cooking or producing a heated dish, characterized by opening the zipper portion of the pouched liquid food product, adding a solid ingredient from the zipper portion into the pouch, closing the zipper portion, and cooking with a microwave oven.
9) A mode relating to a method for using the pouched liquid food product, characterized by opening the zipper portion of the pouched liquid food product, adding a solid ingredient from the zipper portion into the pouch, closing the zipper portion, and cooking with a microwave oven.

Specific mode B is:

“A pouched liquid food product, comprising a liquid food including a condiment and a pouch which is filled therewith and sealed, the pouched liquid food product being subjected to retort processing and being configured such that a heated dish is obtainable by adding one kind or two or more kinds of vegetables selected from leaf vegetables, flower vegetables, and root vegetables into the pouch filled with the liquid food and cooking with a microwave oven, wherein:

the pouch has a zipper portion which serves as an addition aperture of the vegetable and a steam venting mechanism for discharging steam during cooking with a microwave oven;

a liquid substance in the liquid food includes a modified starch and/or a moist heat-treated starch, and the liquid substance has a viscosity of 0.1 to 10 Pa·s; and

a liquid surface of the liquid substance in the pouch, when the pouched liquid food product is made to have a posture for cooking with a microwave oven after adding the vegetables into the pouch, is at a height of 1/10 to ½ the height from a lower edge of the contents to an upper edge of the contents.”.

According to the pouched liquid food product of this specific mode B, the pouch is filled with, as a liquid food which has undergone retort processing, food ingredients such as a condiment, which exclude the vegetable such as Chinese cabbage, broccoli and the like which is expected to be added into the pouch during cooking. Therefore, the consumer can store this pouched liquid food product. Furthermore, by adding a vegetable such as Chinese cabbage, broccoli and the like which is expected to be added into this pouched liquid food product at an appropriate time into the pouch, and cooking the vegetable in the pouch along with the liquid food with a microwave oven, the consumer can easily obtain a heated dish of such vegetable.

Furthermore, for microwave-cooking in which strong heating at a high temperature is unevenly carried out, strong heating has to be carried out for a fairly long duration so that there are no unheated portions due to the uneven heating. However, in the present invention, the microwave-cooking is started with the liquid substance in the liquid food having a viscosity increased to a specific level by using a specific thickener, and in a state where most of the vegetable, such as Chinese cabbage, broccoli and the like, added into the pouch is exposed above the liquid substance. Therefore, problems such as the texture of the vegetable being harmed from excessive heating, and the flavor of the raw ingredients themselves being harmed due to the condiment component being over-soaked in the vegetable, so that the overall dish has a very uniform flavor, can be resolved.

Therefore, according to the pouched liquid food product of specific mode B, a delicious heated dish can be produced using a microwave oven which draws out the desirable texture and taste specific to a vegetable, such as Chinese cabbage, broccoli and the like, even for a heated dish using such vegetables which are particularly required to be suitably cooked in order to obtain the desirable texture and taste.

Furthermore, for the consumer, a delicious heated dish can be easily produced without using a pot or a frying pan, just by preparing a vegetable such as Chinese cabbage, broccoli and the like, and optionally performing a simple precooking step such as cutting or the like. In particular, if the liquid food with which the pouch is pre-filled is a food which takes time to prepare, using this pouched food product is very convenient for the consumer.

Specific mode B includes the following preferred modes a) to h). The details of these modes have already been described above, and thus descriptions thereof are omitted here.
a) A mode in which the expected addition amount of the vegetable is 0.1 to 5 parts by mass based on 1 part by mass of the liquid substance included in the liquid food.
b) A mode in which the maximum filling volume of the pouch is 2 to 10 times the volume of the filled amount of the liquid food.
c) A mode including a descriptive indication about the kind and the added amount of the vegetable which is suitable for addition into the pouch.
d) A mode in which a notch for forming an aperture portion for discharging the dish by tearing is formed in the pouch.
f) A mode in which the heated dish is a nursing food or a hospital food.
g) A mode relating to a method for cooking or producing a heated dish, characterized by opening a zipper portion of the pouched liquid food product, adding one kind or two or more kinds of vegetable selected from leaf vegetables, flower vegetables, root vegetables from the zipper portion into the pouch, and cooking with a microwave oven.
h) A mode relating to a method for using the pouched liquid food product, characterized by opening a zipper portion of the pouched liquid food product, adding one kind or two or more kinds of vegetable selected from leaf vegetables, flower vegetables, root vegetables from the zipper portion into the pouch, closing the zipper portion, and cooking with a microwave oven.

### EXAMPLES

The present invention will now be described in more detail based on the following Examples.

### Test Example 1A

(Japanese mustard spinach boiled and soaked in dashi broth (hereinafter referred to as “boiled-soaked Japanese mustard spinach”): Effect of the ratio X₁/X₂ (%), where X₁ is the salt concentration of the liquid food and X₂ is the salt concentration of the whole contents after addition of the solid ingredient)

### (1) Solid Ingredient

About 100 g of roughly-cut (about 5 cm) Japanese mustard spinach was used as the solid ingredient to be subsequently added into the pouch. The salt concentration of the solid ingredient was 0%.

### (2) Liquid Food, Pouched Liquid Food Product

Among the liquid food ingredients shown in Table 1, soy sauce, mirin (sweet sake), sugar, dashi (Japanese soup stock), salt, and fresh water were mixed in a pot, and the resultant mixture was heated to prepare a condiment liquid.

80 g of this condiment liquid, 10 g of deep-fried tofu (cut into 1 cm widths), and 10 g of carrot (cut into long sticks with a size of 3×3×30 mm) were added into the zippered standing pouch (pouch size: length 220 mm×width 140 mm×fold (gusset) 40 mm; material: (pouch) polyester/polyamide/cast polypropylene, (zipper portion) polypropylene, maximum filling volume: 820 mL) illustrated in FIG. 1 having a steam venting mechanism formed from a weakened seal portion and a notch. The pouch was sealed, and retort processing (115° C., 15 minutes: equivalent to 120° C. for 4 minutes as center portion heat treatment conditions) was carried out, to obtain a pouched liquid food product filled with 100 g of an ingredient-containing condiment liquid as a liquid food in the pouch. The salt concentration of this liquid food was 2%. The viscosity at 60° C. of the condiment liquid (BH type viscometer manufactured by Tokyo Keiki Inc., No. 1 rotor, rotation speed of 20 rpm) was 0.1 Pa·s. The pouch thickness was 0.5 cm.

TABLE 1
Liquid Food (ingredient-containing condiment liquid)

| | Parts by Mass |
|---|---|
| condiment Liquid | |
| Soy sauce | 7 |
| Mirin | 3 |
| Sugar | 3 |
| Bonito dashi (powder) | 1 |
| Salt | 1 |
| Fresh water | 65 |
| Ingredient | |
| Deep-fried tofu | 10 |
| Carrot | 10 |

### (3) Microwave-Cooking

The zipper of the pouched liquid food product from (2) was opened, the 100 g of Japanese mustard spinach from (1) was added, the zipper was again closed, and the pouched liquid food product was placed flat in the microwave oven with its steam venting mechanism facing upwards. The pouched liquid food product was cooked in that state (600 W×4 minutes), then the pouch was opened from the notch for discharging the dish, and the contents were poured onto a large plate. The obtained, boiled-soaked Japanese mustard spinach (salt concentration 1%) was evaluated based on the following criteria regarding the ingredient feeling of the Japanese mustard spinach and the harmoniousness in taste of the boiled-soaked Japanese mustard spinach.

### Ingredient Feeling of Japanese Mustard Spinach

A: Adequate ingredient Feeling of Japanese mustard spinach adequate.
B: Moderate ingredient Feeling of Japanese mustard spinach.
C: Less Ingredient Feeling of Japanese mustard spinach.
D: No Japanese mustard spinach ingredient feeling.

### Harmoniousness in Taste of Boiled-Soaked Japanese Mustard Spinach

A: Delicious flavor in which the Japanese mustard spinach and condiment liquid are thoroughly harmonized with very good balance.
B: Delicious flavor in which the Japanese mustard spinach and condiment liquid are harmonized with good balance.
C: Japanese mustard spinach and condiment liquid are not thoroughly harmonized, and the balance is poor.
D: Japanese mustard spinach and condiment liquid are scarcely harmonized, and the balance is very poor.

### Test Examples 1B to 1I

Boiled-soaked Japanese mustard spinach for each Test Example was obtained in the same manner as in Test Example 1A, except that the added amount of Japanese mustard spinach based on a 100 g filled amount of the liquid food was changed to the amounts shown in Table 2, and further, for cases where the added amount of Japanese mustard spinach was changed, the blended amount of fresh water when blending with the condiment liquid was adjusted so that the salt concentration of the contents after the addition of the Japanese mustard spinach may not change. The obtained, boiled-soaked Japanese mustard spinach for each test Example was evaluated in the same manner as in Test Example 1A.

TABLE 2

| | | | | Salt | | | |
|---|---|---|---|---|---|---|---|
| | | | | Concentration | | | Harmoniousness |
| | | Salt | Added | of Contents | Ratio X₁/X₂ (%) of Salt | | in |
| | | Concentration | Amount | After | Concentration of the | | Taste of |
| | Amount | of | of | Addition of | Liquid Food X₁ (%) to | Ingredient | Boiled- |
| | of | the | Japanese | Japanese | Salt Concentration of | Feeling of | soaked |
| | Liquid | Liquid | Mustard | Mustard | Contents After Addition | Japanese | Japanese |
| Test | Food | Food: X₁ | Spinach | Spinach: X₂ | of Japanese Mustard | Mustard | Mustard |
| Example | (g) | (%) | (g) | (%) | Spinach X₂ (%) | Spinach | Spinach |
| 1B | 100 | 1.01 | 1 | 1 | 101 | D | A |
| 1C | 100 | 1.1 | 10 | 1 | 110 | B | A |
| 1D | 100 | 1.5 | 50 | 1 | 150 | A | A |
| 1E | 100 | 2 | 100 | 1 | 200 | A | A |
| 1F | 100 | 3 | 200 | 1 | 300 | A | A |
| 1G | 100 | 4 | 300 | 1 | 400 | A | B |
| 1H | 100 | 5 | 400 | 1 | 500 | A | D |
| 1I | 100 | 6 | 500 | 1 | 600 | A | D |

From Table 2, it can be seen that if the ratio X₁/X₂ (%) of the salt concentration X₁ of the liquid food to the salt concentration X₂ of the contents after addition of the Japanese mustard spinach is in the range of 110 to 400%, that there is ingredient feeling of a Japanese mustard spinach, and a delicious flavor is obtained in which the Japanese mustard spinach and the condiment liquid are harmonized with a good balance. In contrast, it can be seen that if the above ratio is above this range, the Japanese mustard spinach and condiment liquid are not harmonized, and the balance is very poor.

### Example 1

### Boiled-Soaked Japanese Mustard Spinach

### (1) Solid Ingredient

In the same manner as in Test Example 1A, 100 g of roughly cut (about 5 cm) Japanese mustard spinach was prepared as the solid ingredient to be subsequently added into the pouch.

### (2) Pouched Liquid Food Product

In the same manner as in test example 1A, a pouched liquid food product (pouch thickness 0.5 cm) filled with 100 g of liquid food (viscosity (60° C.)=0.1 Pa·s) was produced.

### (3) Microwave-Cooking

The zipper of the pouched food from (2) was opened, the 100 g of Japanese mustard spinach from (1) was added, the zipper was again closed, and the pouched food was cooked with a microwave oven (600 W×4 minutes).

As a result, a delicious boiled-soaked Japanese mustard spinach was obtained in which the Japanese mustard spinach leaves were not discolored. Furthermore, in the present example, the salt concentration of the liquid food was 200% of a salt concentration of the whole contents after addition of the Japanese mustard spinach. The salt concentration of the obtained, boiled-soaked Japanese mustard spinach was 1%.

### Comparative Example 1A

### Boiled-Soaked Japanese Mustard Spinach/Example in Which Japanese Mustard Spinach Was Added Before the Retort Processing

A pouched liquid food product was obtained in the same manner as in Example 1, except that the 100 g of liquid food was added into the pouch with the 100 g of Japanese mustard spinach during production of the pouched liquid food product, and then the retort processing was carried out. One day later, this pouched liquid food product was heated with a microwave oven (600 W×4 minutes). However, the Japanese mustard spinach leaves were wholly discolored, and in some places the leaves had dissolved, and the boiled-soaked Japanese mustard spinach was not delicious.

### Comparative Example 1B

### Boiled-Soaked Japanese Mustard Spinach/Example in Which Japanese Mustard Spinach and Water Were Added Into a Pouched Liquid Food Product

A pouched liquid food product filled with 35 g of liquid food was obtained by preparing the condiment liquid with the same blending ratios as in Example 1, except that fresh water was not added, filling the pouch with 15 g of the obtained condiment liquid, 10 g of deep-fried tofu, and 10 g of carrots, sealing the pouch, and carrying out the same retort processing as in Example 1. The viscosity at 60° C. of this liquid food was 2 Pa·s.

The zipper of this pouched liquid food product was opened, 100 g of Japanese mustard spinach and 65 g of fresh water were added in the same manner as in Example 1, the zipper was again closed, and the pouched liquid food product was cooked with a microwave oven (600 W×4 minutes) then poured onto a large plate. The obtained, boiled-soaked Japanese mustard spinach had unevenness in the penetration of flavor into the Japanese mustard spinach.

### Example 2

### Creamed Pumpkin

### (1) Solid Ingredient

About 200 g of pumpkin cut into bite sizes (about 3 cm cubic) was used as the solid ingredient to be subsequently added into the pouch. The pumpkin salt concentration was 0%.

### (2) Liquid Food, Pouched Liquid Food Product

The condiment liquid was prepared as follows according to the proportions shown in Table 3.

First, starch, chicken bouillon, flour, butter, salt, and fresh water were added to a pot, and the resultant mixture was heated and stirred. Then, fresh cream, cheese, spices, and mushrooms (2-mm thick slices) were added, and the mixture was heated to obtain a cream sauce.

250 g of this cream sauce was filled into a pouch, and retort processing (115° C., 20 minutes: equivalent to 120° C. for 4 minutes as center portion heat treatment conditions) was carried out, to obtain a pouched liquid food product filled with a cream sauce as the liquid food in the pouch.

As the pouch, a standard pouch provided with a zipper the same as that in Example 1 was used. The salt concentration of this cream sauce was 1.6%. The viscosity at 60° C. of the liquid substance in the cream sauce was 1 Pa·s. Furthermore, the pouch thickness was 1.2 cm.

TABLE 3
Liquid Food (cream sauce)

| | Parts by Mass |
|---|---|
| condiment Liquid | |
| Fresh cream (milkfat content 45%) | 20 |
| Cheese | 5 |
| Starch | 5 |
| Chicken bouillon (powder) | 2 |
| Flour | 2 |
| Butter | 2 |
| Salt | 1 |
| Spices | 1 |
| Fresh water | 47 |
| Ingredient | |
| Mushrooms | 15 |

### (3) Microwave-Cooking

The zipper of the pouched liquid food product obtained in (2) was opened, 200 g of the pumpkin from (1) was added, the zipper was again closed, and the pouched liquid food product was cooked with a microwave oven (600 W×8 minutes) then poured onto a large plate.

As a result, delicious creamed pumpkin was obtained in which the pumpkin was not mushy. Furthermore, in the present Example, the salt concentration of the cream sauce was 178% that of the whole contents after addition of the pumpkin. The salt concentration of the obtained creamed pumpkin was 0.9%.

Furthermore, measurement of the product temperature at three locations of the creamed pumpkin 1 minute after being poured onto the plate showed temperatures of 89° C., 90° C., and 90° C., from which it could be confirmed that the product temperature was uniform.

Furthermore, the ingredient pumpkin was collected from three locations, and the salt concentration at each location was measured. The results were 0.4%, 0.4%, and 0.5%, from which it could be confirmed that the ingredient was uniformly flavored.

### Comparative Example 2A

### Creamed Pumpkin/Example in Which the Pouch Thickness was Changed

A pouched liquid food product was obtained by changing the pouch size from Example 2 to length 140 mm×width 120 mm×fold (gusset) 40 mm, and then carrying out the retort processing (115° C., 30 minutes: equivalent to 120° C. for 4 minutes as center portion heat treatment conditions). The pouch thickness was 3 cm.

Using this pouched liquid food product, creamed pumpkin was obtained in the same manner as in Example 2. The results showed that while the pumpkin was not mushy, compared with the creamed pumpkin of Example 2, the smell of the fresh cream was weak, and the color tone of the liquid substance portion had partially turned brown. Furthermore, the creamed pumpkin was not delicious.

### Comparative Example 2B

### Creamed Pumpkin/Example of Using a Molded Container

The pumpkin of Example 2 (1) and the cream sauce of Example 2 (2) were heated with a microwave oven in a box-shaped container provided with a lid (600 W×8 minutes). After 30 seconds had elapsed with the lid still on, and then 1 minute with the lid off, the product temperature of the creamed pumpkin in the container was measured at three locations. The results showed product temperatures at the three locations of 75° C., 85° C., and 90° C., from which it was learned that there was unevenness.

### Comparative Example 2C

### Creamed Pumpkin/Example of Using a Semisolid Condiment

A pouched food product filled with cream sauce was obtained in the same manner as in Example 2, except that the blended amount of starch in the condiment liquid from Example 2 was increased to 10 parts, and the blended amount of fresh water was consequently reduced by the same amount to prepare a semisolid condiment agent. The viscosity (60° C.) of the liquid substance in the liquid food was 11 Pa·s.

The same pumpkin as from Example 2 (1) was added to this pouched food, and the resultant mixture was cooked with a microwave oven (600 W×8 minutes) to obtain creamed pumpkin. The obtained creamed pumpkin had unevenness in the penetration of flavor into the ingredient pumpkin. Furthermore, the ingredient pumpkin was collected from three locations, and the salt concentration at each location was measured. The results were 0.1%, 0.2%, and 0.7%.

### Comparative Example 2D

### Creamed Pumpkin/Example in Which Pumpkin and Water Were Added Into a Pouched Liquid Food Product

Cream sauce was obtained in the same manner as in Example 2, except that the blended amount of fresh water in the cream sauce from Example 2 was reduced to 17 parts. Next, 175 g of this cream sauce was filled into a pouch, and retort processing was carried out in the same manner as in Example 2 to obtain a pouched food filled with cream sauce in the pouch. The viscosity at 60° C. of the liquid substance in this cream sauce was 6 Pa·s.

The zipper of this pouched food was opened, 200 g of pumpkin and 75 g of fresh water were added in the same manner as in Example 2 (1), the zipper was again closed, and the pouched food was cooked with a microwave oven (600 W×8 minutes) then poured onto a large plate. The obtained creamed pumpkin had unevenness in the penetration of flavor into the ingredient pumpkin. Furthermore, the ingredient pumpkin was collected from three locations, and the salt concentration at each location was measured. The results were 0.4%, 0.7%, and 0.8%.

### Example 3

### Vongole Sauce

### (1) Solid Ingredient

About 100 g of little-neck clams in the shell (edible portion 40%) and about 100 g of cod fillet (one slice cut to a thickness of about 2 cm) were used as solid ingredients to be subsequently added into the pouch. The salt concentration of the solid ingredient edible portion was 0.8%.

### (2) Liquid Food, Pouched Liquid Food Product

According to the proportions shown in Table 4, garlic and red pepper were sauteed in olive oil in a pot, and then anchovies, olives, capers, dried tomatoes, salt, and fresh water were added. The resultant mixture was heated to obtain an ingredient-containing condiment liquid.

200 g of this ingredient-containing condiment liquid was added into a pouch, and retort processing (115° C., 15 minutes: equivalent to 120° C. for 4 minutes as center portion heat treatment conditions) was carried out, to obtain a pouched liquid food product filled with a semi-cooked dish of vongole sauce as the liquid food in the pouch. As the pouch, a standard pouch provided with a zipper the same as that in Example 1 was used.

The salt concentration of this liquid food was 2.2%. The viscosity at 60° C. of the liquid substance in the liquid food was 0.5 Pa·s. Furthermore, the pouch thickness was 1 cm.

TABLE 4

| Liquid Food | |
|---|---|
| (ingredient-containing condiment liquid) | Parts by Mass |
| Olive oil | 20 |
| Garlic | 2 |
| Anchovies | 2 |
| Olives | 2 |
| Capers | 2 |
| Dried tomatoes | 2 |
| Salt | 1.5 |
| Red Pepper | 0.1 |
| Fresh water | 68.4 |

### (3) Microwave-Cooking

The zipper of the pouched liquid food product from (2) was opened, the littleneck clams and the cod fillet from (1) were added, the zipper was again closed, and the pouched liquid food product was cooked with a microwave oven (600 W×6 minutes).

As a result, a delicious vongole sauce was obtained in which the littleneck clams and cod fillet were boiled so as to become tender. Furthermore, in the present example, the salt concentration of the liquid food was 138% that of the whole contents after addition of the littleneck clams and cod fillet. The salt concentration of the obtained vongole sauce was 1.6%.

### Comparative Example 3A

### Vongole Sauce/Example in Which the Littleneck Clams Were Added Before the Retort Processing

A pouched liquid food product was obtained in the same manner as in Example 3, except that the littleneck clams and cod fillet of (1) were added to the pouch with the ingredient-containing condiment liquid of (2) during production of the pouched liquid food product, and then the retort processing was carried out. One day later, this pouched liquid food product was heated with a microwave oven (600 W×6 minutes). However, the littleneck clams and cod fillet had become tough, and the vongole sauce was not delicious.

### Comparative Example 3B

### Vongole Sauce/Example in Which the Pouch Thickness was Changed

A pouched liquid food product was obtained by changing the pouch size from Example 3 to length 140 mm×width 120 mm×fold (gusset) 40 mm, and then carrying out the retort processing (115° C., 30 minutes: equivalent to 120° C. for 4 minutes as center portion heat treatment conditions). The pouch thickness was 2.8 cm.

Although in the vongole sauce obtained in the same manner as in Example 3 using this pouched liquid food product, the littleneck clams and cod fillet did not become tough, the olive and garlic smell was weaker than in Example 3, and the vongole sauce was not delicious.

### Comparative Example 3C

### Vongole Sauce/Example in Which Littleneck Clams and Water Were Added Into a Pouched Liquid Food Product

An ingredient-containing condiment liquid was obtained in the same manner as in Example 3, except that the blended amount of fresh water in the ingredient-containing condiment liquid of Example 3 was reduced to 18.9 parts. Next, 100 g of this ingredient-containing condiment liquid was added into a pouch, and retort processing was carried out in the same manner as in Example 3 to obtain a pouched liquid food product filled with semi-cooked vongole sauce in the pouch as the liquid food. The viscosity of this liquid food was 0.6 Pa·s.

The zipper of this pouched liquid food product was opened, 100 g of littleneck clams in the shell, 100 g of cod fillet, and 100 g of fresh water were added in the same manner as in Example 3, the zipper was again closed, and the pouched food was cooked with a microwave oven (600 W×8 minutes) then poured onto a large plate. The obtained vongole sauce had unevenness in the penetration of flavor to littleneck clams and cod fillet. Furthermore, the flavor balance was not good.

### Example 4

### Pot-au-feu

### (1) Solid Ingredient

About 40 g of potato cut into bite sizes (about 3 cm cubic) and about 25 g of cauliflower cut into bite sizes (about 3 cm cubic) were used as the solid ingredients to be subsequently added into the pouch. The salt concentration of the solid ingredients was 0%.

### (2) Liquid Food

30 parts of carrot (5 mm cubic), 25 parts of chicken (1 cm cubic), 20 parts of onion (5 mm cubic), 2 parts of chicken bouillon (powder), 1 part of salt, and 22 parts of fresh water were added into a pot, and the resultant mixture was boiled. 200 g of this mixture was filled into a pouch, and retort processing (115° C., 22 minutes: equivalent to 120° C. for 4 minutes as center portion heat treatment conditions) was carried out, to obtain a pouched liquid food product filled with a semi-cooked pot-au-feu as the liquid food in the pouch.

As the pouch, a standard pouch provided with a zipper the same as that in Example 1 was used. The salt concentration of this liquid food was 1.5%. The viscosity (60° C.) of the liquid substance in the liquid food was 0.5 Pa·s. Furthermore, the pouch thickness was 1 cm.

### (3) Microwave-Cooking

The zipper of the pouched liquid food product from (2) was opened, the potato and cauliflower from (1) were added, the zipper was again closed, and the pouched liquid food product was cooked with a microwave oven (600 W×6 minutes).

As a result, a delicious pot-au-feu was obtained in which the potato and the cauliflower were not mushy.

Furthermore, in the present example, the salt concentration of the liquid food was 133% that of the whole contents after addition of the solid ingredients. The salt concentration of the obtained pot-au-feu was 1.1%.

### Comparative Example 4

### Pot-au-feu/Example in Which the Salt Concentration of the Liquid Food Was Changed

A pot-au-feu was obtained in the same manner as in Example 4, except that the blending and the solid ingredients of the liquid food in Example 4 were changed.

Namely, first, about 40 g of potato cut into bite sizes (about 3 cm cubic) and about 25 g of cauliflower cut into bite sizes (about 3 cm cubic), 60 g of carrot (5 mm cubic), 50 g of chicken (1 cm cubic), and 40 g of onion (5 mm cubic) were used as solid ingredients to be subsequently added into the pouch.

Next, 2 parts of chicken bouillon (powder), 1 part of salt, and 22 parts of fresh water were added into a pot, and the resultant mixture was boiled. 50 g of this mixture was added into a pouch, and retort processing was carried out to obtain a pouched liquid food product. The salt concentration of this liquid food was 6.0%.

Then, the zipper of the obtained pouched liquid food product was opened, the potato, cauliflower, carrot, chicken, and onion were added, the zipper was again closed, and the pouched liquid food product was cooked with a microwave oven.

As a result, although the potato and the cauliflower were not mushy, in the obtained pot-au-feu, the flavor of the raw ingredients and the condiment liquid had hardly mixed, and the flavor balance was very poor. The salt concentration of the obtained pot-au-feu was 1.1%, and the salt concentration of the liquid food was 545% that of the whole contents after addition of the solid ingredients.

### Example 5

### Boiled Food of Hijiki and Soybean

### (1) Solid Ingredient

55 g of hijiki (steeped in water) was used as the solid ingredient to be subsequently added into the pouch. The salt concentration of the solid ingredient was 0.4%.

### (2) Liquid Food, Pouched Liquid Food Product

An ingredient-containing condiment liquid was prepared as follows according to the proportions shown in Table 5.

First, Japanese sake was added to a pot, and heated to drive off the alcohol. Dashi, soy sauce, mirin, sugar, salt, starch, and fresh water were added, and the resultant mixture was heated and stirred. The mixture was brought to a fixed temperature (about 90° C.) to obtain a condiment liquid.

Next, a total of 200 g of the thus-obtained condiment liquid, soybeans, deep-fried tofu (cut to a width of 1 cm), and carrots (long sticks cut to a size of 3×3×30 mm), were filled into a pouch, and retort processing (115° C., 20 minutes: equivalent to 120° C. for 4 minutes as center portion heat treatment conditions) was carried out, to obtain a pouched liquid food product filled with an ingredient-containing condiment liquid as a semi-cooked food in the pouch.

As the pouch, a standard pouch provided with a zipper the same as that in Example 1 was used. The salt concentration of this liquid food was 2.5%. The viscosity at 60° C. of the liquid substance in the liquid food was 0.8 Pa·s. The pouch thickness was 1 cm.

TABLE 5
Liquid Food (ingredient-containing condiment liquid)

| | Parts by Mass |
|---|---|
| Condiment Liquid | |
| Soy sauce | 10 |
| Japanese sake | 2 |
| Mirin | 2 |
| Bonito dashi (powder) | 1 |
| Sugar | 2 |
| Starch | 2 |
| Salt | 1 |
| Fresh water | 25 |
| Ingredient | |
| Soybeans (boiled product) | 30 |
| Deep-fried tofu | 15 |
| Carrots | 10 |

### (3) Microwave-Cooking

The zipper of the pouched liquid food product obtained in (2) was opened, the hijiki from (1) was added, the zipper was again closed, and the pouched liquid food product was cooked with a microwave oven (600 W×5 minutes).

As a result, a delicious boiled food was obtained which had a powerful hijiki smell. Furthermore, in the present example, the salt concentration of the liquid food was 125% that of the whole contents after addition of the hijiki. The salt concentration of the obtained boiled food was 2.0%.

### Example 6

### Boeuf Bourguignonne

### (1) Solid Ingredient

80 g of sirloin cut into bite sizes (about 3 cm cubic) was used as the solid ingredient to be subsequently added into the pouch. The salt concentration of the solid ingredient was 0.1%.

### (2) Liquid Food, Pouched Liquid Food Product

2 parts of garlic, 12 parts of onion (5 mm cubic), 12 parts of carrot (5 mm cubic), and 2 parts of celery (length 3 cm) were sauteed in 2 parts of canola oil in a pot. Then, 9 parts of tomato, 30 parts of red wine, 1.5 parts of salt, and 29.5 parts of fresh water were added, and the resultant mixture was boiled. 200 g of this mixture was filled into a pouch, and retort processing (115° C., 20 minutes: equivalent to 120° C. for 4 minutes as center portion heat treatment conditions) was carried out, to obtain a pouched liquid food product filled with a red wine sauce as the liquid food in the pouch.

As the pouch, a standard pouch provided with a zipper the same as that in Example 1 was used. The salt concentration of this liquid food was 1.5%. The viscosity at 60° C. of the liquid substance in the liquid food was 1 Pa·s. Furthermore, the pouch thickness was 1 cm.

### (3) Microwave-Cooking

The zipper of the pouched food from (2) was opened, the beef from (1) was added, the zipper was again closed, and the pouched liquid food product was cooked with a microwave oven (600 W×6 minutes).

As a result, a delicious Boeuf bourguignonne was obtained in which the beef was tender. Furthermore, in the present example, the salt concentration of the liquid food was 136% that of the whole contents after addition of the beef. The salt concentration of the obtained Boeuf bourguignonne was 1.1%.

### Example 7

### Chicken Cacciatora

### (1) Solid Ingredient

About 200 g of chicken breast cut into bite sizes (about 3 cm cubic) was used as the solid ingredient to be subsequently added into the pouch. The salt concentration of the solid ingredient was 0.1%.

### (2) Liquid Food, Pouched Liquid Food Product

An ingredient-containing condiment liquid was prepared as follows according to the proportions shown in Table 6.

First, canola oil and garlic were added to a pot, and the pot was heated. Onion was added, and the resultant mixture was heated and stirred. Then, boiled tomatoes, tomato paste, chicken bouillon, sugar, salt, spices, starch, and fresh water were added, and the resultant mixture was brought to a fixed temperature (90° C.) to obtain a condiment liquid.

Next, a total of 30 g of green peas, red kidney beans, and chickpeas were added into a pouch, then 170 g of the above condiment liquid was added into the pouch, and retort processing (115° C., 22 minutes: equivalent to 120° C. for 4 minutes as center portion heat treatment conditions) was carried out, to obtain a pouched liquid food product filled with an ingredient-containing condiment liquid as a liquid food in the pouch.

As the pouch, a standard pouch provided with a zipper the same as that from Example 1 was used. The salt concentration of this liquid food was 1.5%. The viscosity at 60° C. of the liquid substance in the liquid food was 1.5 Pa·s. The pouch thickness was 1 cm.

TABLE 6
Liquid Food (ingredient-containing condiment liquid)

| | Parts by Mass |
|---|---|
| Condiment Liquid | |
| Boiled tomatoes | 10 |
| Tomato paste | 8 |
| Sugar | 6 |
| Canola oil | 5 |
| Chicken bouillon (powder) | 3 |
| Starch | 3 |
| Salt | 1 |
| Spices | 1 |
| Fresh water | 35 |
| Ingredient | |
| Onions | 8 |
| Garlic | 5 |
| Green peas (boiled product) | 5 |
| Red kidney beans (boiled product) | 5 |
| Chickpeas (boiled product) | 5 |

### (3) Microwave-Cooking

The zipper of the pouched liquid food product from (2) was opened, the chicken from (1) was added, the zipper was again closed, and the pouched liquid food product was cooked with a microwave oven (600 W×7 minutes).

As a result, a delicious chicken cacciatora was obtained in which the chicken was boiled so as to become tender. Furthermore, in the present example, the salt concentration of the liquid food was 188% that of the whole contents after addition of the chicken. The salt concentration of the obtained chicken tomato was 0.8%.

### Example 8

### Mackerel Miso Stew

### (1) Solid Ingredient

About 200 g of mackeral (two slices cut to a thickness of about 2 cm) was used as the solid ingredient to be subsequently added into the pouch. The salt concentration of the solid ingredient was 0.4%.

### (2) Liquid Food, Pouched Liquid Food Product

An ingredient-containing condiment liquid was prepared as follows according to the proportions shown in Table 7.

First, miso, sugar, soy sauce, mirin, ginger, starch, and fresh water were added to a pot, and the resultant mixture was heated and stirred to obtain a condiment liquid.

Next, 40 g of taro (frozen, 1 cm cubic) was filled into a pouch, then 160 g of the above condiment liquid was filled into the pouch, and retort processing (115° C., 22 minutes: equivalent to 120° C. for 4 minutes as center portion heat treatment conditions) was carried out, to obtain a pouched liquid food product filled with an ingredient-containing condiment liquid as a liquid food in the pouch.

As the pouch, a standard pouch provided with a zipper the same as that in Example 1 was used. The salt concentration of this liquid food was 2%. The viscosity at 60° C. of the liquid substance in the liquid food was 1 Pa·s. The pouch thickness when laid flat was 1 cm.

TABLE 7
Liquid Food (ingredient-containing condiment liquid)

| | Parts by Mass |
|---|---|
| Condiment Liquid | |
| Miso | 20 |
| Sugar | 10 |
| Soy sauce | 6 |
| Mirin | 5 |
| Starch | 3 |
| Ginger | 1 |
| Fresh water | 35 |
| Ingredient | |
| Taro (frozen) | 20 |

### (3) Microwave-Cooking

The zipper of the pouched liquid food product from (2) was opened, the mackerel from (1) was added, the zipper was again closed, and the pouched liquid food product was cooked with a microwave oven (600 W×5 minutes) then poured onto a large plate.

As a result, a delicious mackerel miso stew was obtained in which the mackerel was boiled so as to become tender. Furthermore, in the present example, the salt concentration of the liquid food was 167% that of the whole contents after addition of the mackerel. The salt concentration of the obtained mackerel miso stew was 1.2%.

### Example 9

### Chicken Cacciatora Diabetic Diet

### (1) Solid Ingredient

About 150 g of chicken breast cut into bite sizes (about 3 cm cubic) with the skin removed was used as the solid ingredient to be subsequently added into the pouch. The salt concentration of the solid ingredient was 0.1%.

### (2) Liquid Food, Pouched Liquid Food Product

An ingredient-containing condiment liquid was prepared as follows according to the proportions shown in Table 8.

First, canola oil and garlic were added to a pot, and the pot was heated. Onion was added, and the resultant mixture was heated and stirred. Then, boiled tomatoes, tomato paste, chicken bouillon, sugar, sucralose, salt, spices, starch, and fresh water were added, and the resultant mixture was brought to a fixed temperature (90° C.) to obtain a condiment liquid.

Next, a total of 30 g of green peas, red kidney beans, and chickpeas were filled into a pouch, then 170 g of the above condiment liquid was filled into the pouch, and retort processing (115° C., 22 minutes: equivalent to 120° C. for 4 minutes as center portion heat treatment conditions) was carried out, to obtain a pouched liquid food product filled with an ingredient-containing condiment liquid as a liquid food in the pouch.

As the pouch, a standard pouch provided with a zipper the same as that from Example 1 was used. The salt concentration of this liquid food was 1.5%. The viscosity (60° C.) of the liquid substance in the liquid food was 1.5 Pa·s. The pouch thickness was 1 cm.

TABLE 8
Liquid Food (ingredient-containing condiment liquid)

| | Parts by Mass |
|---|---|
| Condiment Liquid | |
| Boiled tomatoes | 10 |
| Tomato paste | 8 |
| Canola oil | 5 |
| Chicken bouillon (powder) | 3 |
| Starch | 3 |
| Salt | 1 |
| Spices | 1 |
| Sugar | 0.99 |
| Sucralose | 0.01 |
| Fresh water | 40 |
| Ingredient | |
| Onions | 8 |
| Garlic | 5 |
| Green peas (boiled product) | 5 |
| Red kidney beans (boiled product) | 5 |
| Chickpeas (boiled product) | 5 |

### (3) Microwave-Cooking

The zipper of the pouched liquid food product from (2) was opened, the chicken from (1) was added, the zipper was again closed, and the pouched liquid food product was cooked with a microwave oven (600 W×7 minutes).

As a result, a delicious chicken cacciatora for diabetic food was obtained in which the chicken was boiled so as to become tender. Furthermore, in the present example, the salt concentration of the liquid food was 167% that of the whole contents after addition of the chicken. The salt concentration of the obtained chicken cacciatora was 0.9%. Furthermore, the number of calories of the chicken cacciatora for diabetic food was 240 kcal.

### Example 10

### Nursing Food of White Fish Dressed With a Thick Starchy Sauce

### (1) Solid Ingredient

About 150 g of cod diced into 2 cm cubic with the skin removed (salt was removed from salt-cured product) was used as the solid ingredient to be subsequently added into the pouch. The salt concentration of the solid ingredient was 0.4%.

### (2) Liquid Food, Pouched Liquid Food Product

An ingredient-containing condiment liquid was prepared as follows according to the proportions shown in Table 9.

First, soy sauce, concentrated bonito dashi, mirin, sugar, salt, modified starch, ginger, and fresh water were added to a pot, and the resultant mixture was heated while stirring. Daikon radish (frozen product diced into 1 cm cubic), carrot (frozen product diced into 1 cm cubic), and shiitake mushrooms (obtained by steeping a dried product diced into 2 mm cubic in water) were further added, and the resultant mixture was heated and stirred, then brought to a fixed temperature (90° C.) to obtain a liquid food.

Next, 150 g of the above liquid food was filled into a pouch, and retort processing (115° C., 15 minutes: equivalent to 120° C. for 4 minutes as center portion heat treatment conditions) was carried out, to obtain a pouched liquid food product filled with an ingredient-containing condiment liquid as a liquid food in the pouch.

As the pouch, a standard pouch provided with a zipper the same as that in Example 1 was used. The salt concentration of this liquid food was 1.8%. The viscosity (60° C.) of the liquid substance in the liquid food was 4.5 Pa·s. The pouch thickness was 0.7 cm.

TABLE 9
Liquid Food (ingredient-containing condiment liquid)

| | Parts by Mass |
|---|---|
| Condiment Liquid | |
| Soy sauce | 5 |
| Concentrated bonito dashi | 3 |
| Mirin | 5 |
| Sugar | 5 |
| Salt | 1 |
| Modified starch | 5 |
| Ginger (minced) | 1 |
| Fresh water | 48 |
| Ingredient | |
| Daikon radish (frozen product) | 15 |
| Carrots (frozen product) | 10 |
| Shiitake mushrooms (dried, steeped | 2 |
| in water) | |

### (3) Microwave-Cooking

The zipper of the pouched liquid food product from (2) was opened, the cod from (1) was added, the zipper was again closed, and the pouched liquid food product was cooked with a microwave oven (600 W×7 minutes).

As a result, a delicious nursing food of white fish dressed with a thick starchy sauce (food for people having difficulty in chewing and swallowing) was obtained in which the cod was boiled so as to become tender. Furthermore, in the present example, the salt concentration of the liquid food was 164% that of the whole contents after addition of the white fish. The salt concentration of the obtained white fish dressed with a thick starchy sauce was 1.1%.

### Example 11

### Chinese Cabbage Heated Dish

### (1) Added Vegetable

About 100 g of Chinese cabbage cut into bite sizes (about 35×50 mm) was used as the vegetable to be subsequently added into the pouch.

### (2) Liquid Food, Pouched Liquid Food Product

Among the liquid food ingredients shown in Table 10, oyster sauce, soy sauce, canola oil, modified starch (Acetylated distarch adipate, manufactured by Nippon NSC Ltd., trade name: “Colflo 67”), sugar, salt, ginger paste, and fresh water were mixed in a pot, and the resultant mixture was heated to prepare a condiment liquid.

Furthermore, carrot, bamboo shoots, pork, and kamaboko fish paste were each cut into long sticks with a size of 3×3×30 mm. Next, 100 g of the thus-obtained condiment liquid, 15 g of carrots, 15 g of bamboo shoots, 10 g of pork, and 10 g of kamaboko fish paste were filled into the zippered standing pouch (pouch size: length 220 mm×width 140 mm×fold (gusset) 40 mm; material: (pouch) polyester/polyamide/cast polypropylene, (zipper portion) polypropylene, maximum filling volume: 820 mL) illustrated in FIG. 1 having a steam venting mechanism formed from a weakened seal portion and a notch. The pouch was sealed, and then retort processing (115° C., 15 minutes: equivalent to 120° C. for 4 minutes as center portion heat treatment conditions) was carried out, to obtain a pouched liquid food product filled with 150 g (150 mL) of an ingredient-containing condiment liquid as a liquid food in the pouch. The salt concentration of this liquid food was 2%. The viscosity of the condiment liquid (product temperature 60° C., BH type viscometer manufactured by Tokyo Keiki Inc., No. 3 rotor, rotation speed of 20 rpm) was 3 Pa·s. The pouch thickness was 0.7 cm.

TABLE 10
Liquid Food (ingredient-containing condiment liquid)

| | Parts by Mass |
|---|---|
| condiment Liquid | |
| Oyster sauce | 5 |
| Soy sauce | 5 |
| Canola oil | 5 |
| Modified starch | 3 |
| Sugar | 3 |
| Salt | 1 |
| Giner paste | 1 |
| Fresh water | 77 |
| Ingredient | |
| Carrots | 15 |
| Bamboo shoots | 15 |
| Pork | 10 |
| Kamaboko fish paste | 10 |

### (3) Microwave-Cooking

The zipper of the pouched liquid food product from (2) was opened, the 100 g of Chinese cabbage from (1) was added, and the zipper was again closed. The pouch thickness after the Chinese cabbage was added was 5 cm. Next, the pouched liquid food product added with Chinese cabbage was placed flat in the microwave oven with its steam venting mechanism facing upwards. The liquid surface of the liquid substance in this case was located at a height of ⅕ the height of from the lower edge of the contents to the upper edge of the contents. The pouched liquid food product was cooked with the microwave oven (600 W×4 minutes), then the pouch was opened from the notch for discharging the dish, and the contents were poured onto a large plate.

The obtained Chinese cabbage heated dish had a desirable texture such as crispiness and a sweet taste both specific to Chinese cabbages. Furthermore, there was no unevenness in the flavoring, and the Chinese cabbage heated dish was very delicious.

### Example 12

### Bok-Choy Heated Dish

### (1) Added Vegetable

About 100 g of bok-choy roughly cut (about 50 mm) was used as the vegetable to be subsequently added into the pouch.

### (2) Liquid Food, Pouched Liquid Food Product

Among the liquid food ingredients shown in Table 11, chicken bouillon, moist heat-treated starch (“Novation 2300”, manufactured by Nippon NSC Ltd.), sugar, salt, and fresh water were mixed in a pot, and the resultant mixture was heated to prepare a condiment liquid.

Next, 100 g of the thus-obtained condiment liquid and 10 g of crab flakes were added into the zippered standing pouch used in Example 1. The pouch was sealed, and then retort processing (115° C., 15 minutes: equivalent to 120° C. for 4 minutes as center portion heat treatment conditions) was carried out, to obtain a pouched liquid food product filled with 110 g (110 mL) of an ingredient-containing condiment liquid as a liquid food in the pouch. The salt concentration of this liquid food was 1%. The viscosity of the condiment liquid (product temperature 60° C., BH type viscometer manufactured by Tokyo Keiki Inc., No. 3 rotor, rotation speed of 20 rpm) was 2 Pa·s. The pouch thickness was 0.5 cm.

TABLE 11
Liquid Food (ingredient-containing condiment liquid)

| | Parts by Mass |
|---|---|
| condiment Liquid | |
| Chicken bouillon (powder) | 5 |
| Moist heat-treated starch | 3 |
| Sugar | 1 |
| Salt | 1 |
| Fresh water | 90 |
| Ingredient | |
| Crab flakes | 10 |

### (3) Microwave-Cooking

The zipper of the pouched liquid food product from (2) was opened, the 100 g of bok-choy from (1) was added, and the zipper was again closed. The pouch thickness after addition of the bok-choy was 3 cm. Next, the pouched liquid food product added with bok-choy was placed flat in the microwave oven with its steam venting mechanism facing upwards. The liquid surface of the liquid substance in this case was located at a height of 3/10 the height from the lower edge of the contents to the upper edge of the contents. The pouched liquid food product was cooked with the microwave oven (600 W×4 minutes), then the pouch was opened from the notch for discharging the dish, and the contents were poured onto a large plate.

The obtained bok-choy heated dish had a desirable texture such as crispiness and a sweet taste both specific to bok-choy. Furthermore, there was no unevenness in the flavoring, and the bok-choy heated dish was very delicious.

### Example 13

### Broccoli Heated Dish

### (1) Added Vegetable

About 150 g of broccoli cut into bite sizes (about 50 mm) was used as the vegetable to be subsequently added into the pouch.

### (2) Liquid Food, Pouched Liquid Food Product

Among the liquid food ingredients shown in Table 12, chicken bouillon, modified starch (Hydroxypropyl distarch phosphate, “Delica M-9”, manufactured by Nippon Starch Chemical Co. Ltd.), sugar, salt, and fresh water were mixed in a pot, and the resultant mixture was heated to prepare a condiment liquid.

Next, 150 g of the thus-obtained flavoring liquid was added into the zippered standing pouch used in Example 1. The pouch was sealed, and then retort processing (115° C., 15 minutes: equivalent to 120° C. for 4 minutes as center portion heat treatment conditions) was carried out, to obtain a pouched liquid food product filled with 150 g (150 mL) of a flavoring liquid as a liquid food in the pouch. The salt concentration of this liquid food was 1%. The viscosity of the condiment liquid (product temperature 60° C., BH type viscometer manufactured by Tokyo Keiki Inc., No. 4 rotor, rotation speed of 20 rpm) was 4 Pa·s. The pouch thickness was 0.7 cm.

TABLE 12

| Liquid Food | Parts by Mass |
|---|---|
| Chicken bouillon (powder) | 5 |
| Modified starch | 3 |
| Sugar | 1 |
| Salt | 1 |
| Fresh water | 90 |

### (3) Microwave-Cooking

The zipper of the pouched liquid food product from (2) was opened, the 150 g of broccoli from (1) was added, and the zipper was again closed. The pouch thickness after the broccoli was added was 6 cm. Next, the pouched liquid food product added with broccoli was placed flat in the microwave oven with its steam venting mechanism facing upwards. The liquid surface of the liquid substance in this case was located at a height of ⅕ the height from the lower edge of the contents to the upper edge of the contents. The pouched liquid food product was cooked with the microwave oven (600 W×6 minutes), then the pouch was opened from the notch for discharging the dish, and the contents were poured onto a large plate.

The obtained broccoli heated dish had a desirable texture such as crispiness and a sweet taste both specific to broccoli. Furthermore, there was no unevenness in the flavoring, and the broccoli heated dish was very delicious.

### Example 14

### Daikon Radish Heated Dish

### (1) Added Vegetable

About 100 g of daikon radish cut into bite sizes (about 30×30×20 mm) was used as the vegetable to be subsequently added into the pouch.

### (2) Liquid Food, Pouched Liquid Food Product

Among the liquid food ingredients shown in Table 13, first, ground pork was added to a pot and sauteed, then soy sauce, modified starch (Acetylated distarch phosphate, “Neobis C10”, manufactured by Nihon Shokuhin Kako Co., Ltd.), mirin, refined sake, bonito extract, ginger paste, and fresh water were added to the pot, and the resultant mixture was mixed and heated to prepare a flavoring liquid.

Next, 130 g of the thus-obtained flavoring liquid was added into the zippered standing pouch used in Example 1. The pouch was sealed, and then retort processing (115° C., 15 minutes: equivalent to 120° C. for 4 minutes as center portion heat treatment conditions) was carried out, to obtain a pouched liquid food product filled with 130 g (130 mL) of an ingredient-containing flavoring liquid as a liquid food in the pouch. The salt concentration of this liquid food was 1%. The viscosity of the condiment liquid (product temperature 60° C., BH type viscometer manufactured by Tokyo Keiki Inc., No. 3 rotor, rotation speed of 20 rpm) was 2 Pa·s. The pouch thickness was 0.7 cm.

TABLE 13
Liquid Food (ingredient-containing flavoring liquid)

| | Parts by Mass |
|---|---|
| Flavoring Liquid | |
| Soy sauce | 5 |
| Modified starch | 3 |
| Mirin | 3 |
| Refined sake | 3 |
| Bonito extract | 1 |
| Ginger paste | 1 |
| Fresh water | 84 |
| Ingredient | |
| Ground pork | 30 |

### (3) Microwave-Cooking

The zipper of the pouched liquid food product from (2) was opened, the 100 g of daikon radish from (1) was added, and the zipper was again closed. The pouch thickness after the daikon radish was added was 5 cm. Next, the pouched liquid food product added with daikon radish was placed flat in the microwave oven with its steam venting mechanism facing upwards. The liquid surface of the liquid substance in this case was located at a height of 3/10 the height from the lower edge of the contents to the upper edge of the contents. The pouched liquid food product was cooked with the microwave oven (600 W×10 minutes), then the pouch was opened from the notch for discharging the dish, and the contents were poured onto a large plate.

The obtained daikon radish heated dish had a desirable texture such as crispiness and a sweet taste both specific to daikon radish. Furthermore, there was no unevenness in the flavoring, and the daikon radish heated dish was very delicious.

### Test Example 2

In the present test example, the following tests were carried out to examine any influences which the height of the liquid surface of a liquid food in the pouch, when the pouched liquid food product is made to have a posture for cooking with a microwave oven after adding a vegetable into the pouch, has on the texture and taste of the cooked vegetable. Namely, first, among the liquid food ingredients shown in Table 14, in the same manner as in Example 11, oyster sauce, soy sauce, canola oil, modified starch, sugar, salt, ginger paste, and fresh water were mixed in a pot, and the resultant mixture was heated to prepare a flavoring liquid. 220 g, 200 g, 180, g, 150 g, 100 g, and 50 g of this flavoring liquid were added into pouches used in Example 11, respectively. Retort processing was then carried out in the same manner as in Example 11, to obtain six kinds of pouched liquid food products filled with a flavoring liquid as a liquid food in the pouch.

Next, Chinese cabbage cut into bite sizes (about 35×50 mm) was prepared as the vegetable to be subsequently added into the pouches. The zippers of the respective pouched liquid food products having different added amounts of flavoring liquid were opened, and the respective amounts shown in Table 14 of the prepared Chinese cabbage were added into the pouches. The zippers were then closed. Next, the pouched liquid food products added with Chinese cabbage were placed flat in the microwave oven with the steam venting mechanism facing upwards, and cooked in that state. The pouches were opened from the notch for discharging the dish, and the contents were then poured onto a large plate. To perform a case of excessive heating, the cooking conditions with the microwave oven were set to 600 W×6 minutes.

Each of the obtained dishes was evaluated based on the following evaluation criteria for the texture and taste of the Chinese cabbage, and for unevenness in seasoning of the overall dish. Furthermore, the height of the liquid surface of the liquid substance with respect to the height from the lower edge of the contents to the upper edge of the contents was measured for each of the pouched liquid food products in the pouch in a posture when they were cooked with the microwave oven. The results are shown in Table 14.

### <Chinese Cabbage Texture>

A: Desirable texture such as crispiness specific to Chinese cabbages is obtained.
B: Crisp texture specific to Chinese cabbages is slightly weak, but still at an acceptable level.
C: Crisp texture specific to Chinese cabbages is slightly weak.
D: Chinese cabbage texture is soft and crisp texture specific to Chinese cabbages is completely absent.

### <Chinese Cabbage Taste>

A: sweet taste specific to Chinese cabbages is obtained.
B: Sweet taste specific to Chinese cabbages is slightly weak, but still at an acceptable level.
C: Sweet taste specific to Chinese cabbages is slightly weak.
D: Sweet taste specific to Chinese cabbages is completely absent.

### <Unevenness in the Flavoring of the Overall Dish>

A: No unevenness in flavoring is obtained.
B: A slight unevenness in flavoring is obtained, but still at an acceptable level.
C: A slight unevenness in flavoring is obtained.
D: Unevenness in flavoring is obtained.

TABLE 14

| | | | Height of | | | |
|---|---|---|---|---|---|---|
| | | | the Liquid | | | |
| | | | Surface of | | | |
| | | | Liquid | | | |
| | | | Substance | | | |
| | | | With | | | |
| | | | Respect to | | | |
| | | | Height from | | | |
| | | Chinese | Lower Edge | | | |
| | Liquid | Cabbage | of Contents | Dish | | |
| | Food | Added | to Upper | Chinese | Chinese | |
| | Amount | Amount | Edge of | Cabbage | Cabbage | Flavoring |
| Test Product | (g) | (g) | Contents | Texture | Taste | Unevenness |
| 2-1 | 220 | 30 | 9/10 | D | D | A |
| 2-2 | 200 | 50 | 1/2 | B | B | A |
| 2-3 | 180 | 70 | 2/5 | A | A | A |
| 2-4 | 150 | 100 | 1/5 | A | A | A |
| 2-5 | 100 | 150 | 1/10 | A | A | B |
| 2-6 | 50 | 200 | 1/20 | A | A | D |

From Table 14, it can be understood that when the height of the liquid surface of the liquid substance in the pouch in a posture when cooking with the microwave oven was performed was located at a height of 1/10 to ½ the height from the lower edge of the contents to the upper edge of the contents (Test Products 2-2 to 2-5), a delicious cooked dish which drew out the desirable texture and taste specific to Chinese cabbage was obtained even when excessive heating by the microwave oven was carried out. In contrast, when the liquid surface of the liquid substance was higher than the above-described height, and the microwave-cooking was started with most of the Chinese cabbage added to the pouch immersed in the liquid substance (Test Product 2-1), the texture of the Chinese cabbage was damaged due to excessive heating. Moreover, the condiment component was over-soaked in the Chinese cabbage, so that the taste of the Chinese cabbage was harmed and the resultant dish was not delicious. On the other hand, when the liquid surface of the liquid substance was lower than the above-described height, and the microwave-cooking was started with most of the Chinese cabbage added to the pouch not being immersed in the liquid substance (Test Product 2-6), unevenness in the flavor of the dish could not be adequately eliminated even by stirring the liquid food and the Chinese cabbage by opening the pouch heated with the microwave oven and transferring the contents onto a plate.

### Test Example 3

In the present test example, the following tests were carried out to examine any influences which the viscosity of the liquid substance in a pouched liquid food product has on the texture and taste of a vegetable cooked with a microwave oven. Namely, first, five kinds of condiment liquid having different viscosities were prepared in the same manner as in Example 11, except that the blended amount of modified starch in the condiment liquid mixture in the liquid food of Example 11 was changed to respectively 0.1 parts, 0.8 parts, 3 parts, 5 parts, and 7 parts. 200 g each of these condiment liquids was filled into a pouch used in Example 11. Retort processing was then carried out in the same manner as in Example 11, to obtain five kinds of pouched liquid food products filled with a condiment liquid as a liquid food in the pouch.

Next, Chinese cabbage cut into bite sizes (about 35×50 mm) was prepared as the vegetable to be subsequently added into the pouches. The zippers of the respective pouched liquid food products having different viscosities of the condiment liquid were opened, and 50 g of the prepared Chinese cabbage was respectively filled into each of the pouches. The zippers were then closed. Next, the pouched liquid food products added with Chinese cabbage were placed flat in the microwave oven with the steam venting mechanism facing upwards, and cooked in that state. The pouches were opened from the notch for discharging the dish, and the contents were then poured onto a large plate. To perform a case of excessive heating, the cooking conditions with the microwave oven were 600 W×6 minutes.

Each of the obtained dishes was evaluated based on the same evaluation criteria as in Test Example 2 for the texture and taste of the Chinese cabbage, and for unevenness in flavoring of the overall dish. The results are shown in Table 15.

TABLE 15

| | Condiment | Dish | | |
|---|---|---|---|---|
| | Liquid | Chinese | Chinese | |
| Test | Viscosity | Cabbage | Cabbage | Flavoring |
| Product | (Pa · s) | Texture | Taste | Unevenness |
| 3-1 | 0.03 | C | C | B |
| 3-2 | 0.5 | B | B | A |
| 3-3 | 3 | A | A | A |
| 3-4 | 7 | A | A | A |
| 3-5 | 12 | A | A | C |

From Table 15, it can be understood that when the viscosity of the liquid substance in the liquid food was 0.1 to 10 Pa·s (Test Products 3-2 to 3-4), a delicious cooked dish which drew out the desirable texture and taste specific to Chinese cabbages was obtained even when excessive heating by the microwave oven was carried out. In contrast, when the viscosity was lower than the above-described range (Test Product 3-1), the texture of the Chinese cabbage was damaged due to excessive heating. Moreover, the condiment ingredient was over-soaked in the Chinese cabbage, so that the taste of the Chinese cabbage was harmed and the resultant dish was not delicious. On the other hand, when the viscosity was higher than the above-described range (Test Product 3-5), unevenness in the flavoring of the dish could not be adequately eliminated even by stirring the liquid food and the Chinese cabbage by opening the pouch heated with the microwave oven and transferring the contents onto a plate.

### Comparative Example 5

A pouched liquid food product filled with an ingredient-containing condiment liquid as a liquid food in the pouch was obtained in the same manner as in Example 11, except that the modified starch in Example 11 was not blended into the liquid food. Instead, 10 parts of raw starch (potato starch, Matsutani Chemical Industry Co., Ltd., Trade name: “Stabilose FS-1”) was blended, and the blended amount of fresh water was consequently reduced by the same amount. The viscosity at 60° C. of the liquid substance in the liquid food was 2.8 Pa·s.

In the same manner as in Example 11, except for using the obtained pouched liquid food product, the zipper of the pouched liquid food product was opened, the Chinese cabbage was added, then the zipper was again closed, and the pouched liquid food product was cooked with a microwave oven. The pouch was opened from the notch for discharging the dish, and the contents were then poured onto a large plate.

The obtained Chinese cabbage cooked dish had a desirable texture such as crispiness and a sweet taste both specific to Chinese cabbages. However, there was slight unevenness in the flavoring of the Chinese cabbage.

### Comparative Example 6

A pouched liquid food product filled with an ingredient-containing condiment liquid as a liquid food in the pouch was obtained in the same manner as in Example 1, except that modified starch in Example 1 was not blended into the liquid food. Instead, 0.5 parts of guar gum was blended, and the blended amount of fresh water was consequently reduced by the same amount. The viscosity at 60° C.) of the liquid substance in the liquid food was 3.5 Pa·s.

In the same manner as in Example 11, except for using the obtained pouched liquid food product, the zipper of the pouched liquid food product was opened, the Chinese cabbage was added, then the zipper was again closed, and the pouched liquid food product was cooked with a microwave oven. The pouch was opened from the notch for discharging the dish, and the contents were then poured onto a large plate.

The obtained Chinese cabbage cooked dish had a desirable texture such as crispiness and a sweet taste both specific to Chinese cabbages. However, there was slight unevenness in the flavoring of the Chinese cabbage.

### INDUSTRIAL APPLICABILITY

The pouched liquid food product of the present invention is useful as a food which aids in the easy production of a delicious heated dish obtained by a consumer using a microwave oven, which harnesses the color, smell, texture and the like of a fresh food, especially a heated dish which draws out the desirable texture and taste specific to a vegetable, such as Chinese cabbage, broccoli and the like.

1. A pouched liquid food product, comprising a liquid food and a pouch filled therewith and sealed, the pouched liquid food product being subjected to retort processing and being configured such that a heated dish is obtainable by adding a solid ingredient into the pouch and cooking with a microwave oven, wherein:
the pouch has a zipper portion which serves as an addition aperture of the solid ingredient and a steam venting mechanism for discharging steam during cooking with a microwave oven;
a liquid substance in the liquid food has a viscosity at 60° C. of 0.1 to 10 Pa·s; and
a relationship between the liquid food and the solid ingredient satisfies at least one of following conditions (a) to (d):
(a) the liquid food has a salt concentration which is 110 to 400% of a salt concentration of the whole contents after addition of the solid ingredient;
(b) a liquid surface of the liquid substance in the pouch, when the pouched liquid food product is made to have a posture for cooking with a microwave oven after adding the solid ingredient into the pouch, is at a height of 1/10 to ½ the height from a lower edge of the contents to an upper edge of the contents;
(c) a maximum filling volume of the pouch is 2 to 10 times the volume of a filled amount of the liquid food; and
(d) an expected addition amount of the solid ingredient is 0.1 to 5 parts by mass based on 1 part by mass of the liquid substance included in the liquid food.

2. The pouched liquid food product according to claim 1, further comprising a modified starch and/or a moist heat-treated starch.

3. The pouched liquid food product according to claim 1, wherein a thickness of the pouch, when the pouched liquid food product is placed flat, is 2 cm or less.

4. The pouched liquid food product according to claim 1, having a salt concentration of 4% or less.

5. The pouched liquid food product according to claim 1, having undergone preparatory cooking before the retort processing.

6. The pouched liquid food product according to claim 1, comprising a descriptive indication about a kind and an addition amount of the solid ingredient which is suitable for addition into the pouch.

7. The pouched liquid food product according to claim 1, wherein the solid ingredient is one kind or two or more kinds selected from leaf vegetables, flower vegetables, root vegetables, fruit vegetables, fruit, seafood, farmed meats, mushrooms, and sea vegetables.

8. The pouched liquid food product according to claim 1, wherein a notch for forming an aperture portion for discharging the dish by tearing is formed in the pouch.

9. The pouched liquid food product according to claim 1, wherein the heated dish is a nursing food or a hospital food.

10. A method for cooking or producing a heated dish, comprising opening the zipper portion of the pouched liquid food product according to claim 1, adding a solid ingredient from the zipper portion into the pouch, closing the zipper portion, and cooking with a microwave oven.

11. A method for using the pouched liquid food product according to claim 1, comprising opening the zipper portion of the pouched liquid food, adding a solid ingredient from the zipper portion into the pouch, closing the zipper portion, and cooking with a microwave oven.

12. A pouched liquid food product, comprising a liquid food and a pouch filled therewith and sealed, the pouched liquid food product being subjected to retort processing and being configured such that a heated dish is obtainable by adding a solid ingredient into the pouch filled with the liquid food and cooking with a microwave oven, wherein:
the pouch has a zipper portion which serves as an addition aperture of the solid ingredient and a steam venting mechanism for discharging steam during cooking with a microwave oven;
a liquid substance in the liquid food has a viscosity (60° C.) of 0.1 to 10 Pa·s;
the liquid food has a salt concentration which is 110 to 400% of a salt concentration of the whole contents after addition of the solid ingredient; and
a pouch thickness when the pouched liquid food product is placed flat is 2 cm or less.

13. A pouched liquid food product, comprising a liquid food which includes a condiment and a pouch which is filled therewith and sealed, the pouched liquid food product being subjected to retort processing and being configured such that a heated dish is obtainable by adding one kind or two or more kinds of vegetables selected from leaf vegetables, flower vegetables, and root vegetables into the pouch filled with the liquid food and cooking with a microwave oven, wherein:
the pouch has a zipper portion which serves as an addition aperture of the vegetable and a steam venting mechanism for discharging steam during cooking with a microwave oven;
a liquid substance in the liquid food includes a modified starch and/or a moist heat-treated starch, and the liquid substance has a a viscosity at 60° C. of 0.1 to 10 Pa·s; and
a liquid surface of the liquid substance in the pouch, when the pouched liquid food product is made to have a posture for cooking with a microwave oven after adding the vegetables into the pouch, is at a height of 1/10 to ½ the height from a lower edge of the contents to an upper edge of the contents.
